(19) United States
(12) Patent Application Publication
(10) Pub. No.: US 2014/0032709 A1
(43) Pub. Date: Jan. 30, 2014

(54) SYSTEMS, METHODS, AND COMPUTER PROGRAM PRODUCTS FOR RECEIVING A FEED MESSAGE

(71) Applicant: JVL Ventures, LLC, New York, NY (US)

(72) Inventors: Gordon C. Saussy, Potomac, MD (US); Robert C. Sprogis, Oak Hill, VA (US); Manish Jain, Bangalore (IN)

(21) Appl. No.: 13/945,382

(22) Filed: Jul. 18, 2013

Related U.S. Application Data
(60) Provisional application No. 61/675,947, filed on Jul. 26, 2012.
(60) Provisional application No. 61/676,227, filed on Jul. 26, 2012.

(51) Int. Cl. H04L 29/08

(52) U.S. Cl. CPC H04L 67/26
USPC 709/217

(57) ABSTRACT

An apparatus, method, and computer readable storage medium for receiving a feed message from an external party system. The feed message is received from an external party system, and includes message content, which may be text, images, or a combination thereof, and one or more sets of instructions. The message content can be displayed on a display which can receive one or more commands. A plurality of message acknowledgments can also be generated, including any one of: a received message acknowledgment when the feed message is received, a viewed message acknowledgment when the message content is displayed, and an operated message acknowledgment when the one or more sets of instructions are executed, or a combination thereof. The plurality of message acknowledgments can be stored in a memory, and transmitted to a remote server.

### CROSS REFERENCE TO RELATED APPLICATION

This application claims priority to U.S. Provisional Application Nos. 61/675,947 and 61/676,227 filed Jul. 26, 2012, the contents of which are herein incorporated by reference.

### BACKGROUND OF THE INVENTION

1. Field of the Invention

The present invention generally relates to delivering information to a mobile platform. More particularly, to systems, methods, and computer program products for sending information to a mobile device.

2. Related Art

Mobile devices, e.g. mobile phones and tablets, have become multidimensional tools capable of accomplishing a variety of tasks. No longer confined to merely making and receiving phone calls, mobile devices are capable of accessing email, the Internet, and remote networks. Recent advances in mobile devices have now allowed consumers to turn to their mobile devices to make purchases, resulting in a burgeoning mobile commerce environment.

In a mobile commerce environment, a user can use their mobile device to browse, compare, buy, and review products and services. Despite the rise of mobile commerce, merchants are constantly seeking new ways to reach current and potential customers. Still today, typical merchant environments are only equipped to reach out to customers by sending them coupons, specials, and advertisements by email. These methods, however, are out of place in mobile commerce.

Merchants using existing means of electronic communication, such as electronic mail (email), short message service (SMS), or Twitter messages (tweets), have several drawbacks. A traditional email system is designed to retain emails indefinitely, thus, necessitating the active involvement of the recipient. If the recipient does not actively manage their inbox by periodically “cleaning out” unwanted emails, then the number of unwanted emails can quickly overwhelm the inbox. The tediousness of this task is one reason the public has a developed a negative opinion of emails which are solely for the purposes of solicitation or advertisement, now commonly referred to as “junk” emails or “spam.” Many email service providers have developed complex algorithms which filter incoming emails to eliminate those which are solicitations and/or advertisements. Thus, from a merchant's point of view, email is sometimes seen as an unreliable system for communicating with current and potential customers, since the emails may in fact never reach the customer or be summarily deleted.

Furthermore, the proliferation of viruses and malware embedded in emails have made the public wary of opening an email from an untrusted source, further increasing the likelihood that the email will not be read. Still further, distributing information via email requires the merchant to maintain large databases of users, which must be constantly updated with acquired or purchased information, increasing the cost of engaging the consumer.

Since merchant emails are likely to go unread, there is a tendency to place as much information as possible into an email, in the hope that if it is read, the customer may act on one of the inducements, thereby generating a return on the investment in advertising. This strategy, however, can backfire as the customer suffers an “information overload” and chooses instead to delete the email. While SMS messages and Tweets limit the amount of information presented to the customer, these limitations also restrict the ability of the merchant to communicate with the customer.

### BRIEF DESCRIPTION

The present invention provides apparatuses, methods, and computer readable mediums for receiving a feed message from an external party system.

In one embodiment, an apparatus is constructed to receive a feed message from an external party system. The apparatus includes a memory, and a communication unit configured to receive at least one feed message from a mobile network. The at least one feed message includes message content provided by an external party system and one or more sets of instructions. The apparatus also includes a processor configured to: cause a display unit, which can receive one or more input commands, to display the message content, generate a plurality of message acknowledgments, including any one of: (i) a received message acknowledgment when the at least one feed message is received by the communication unit, (ii) a viewed message acknowledgment when the message content is displayed on the display unit, and (iii) an operated message acknowledgment when the one or more sets of instructions are executed in accordance with the one or more input commands received by the display unit, or a combination thereof, and store one or more of the plurality of message acknowledgments in the memory. The processor is further configured to synchronize with a remote server and transmit to the remote server the one or more message acknowledgments stored in the memory.

In another embodiment, a method of receiving a feed message and transmitting information related thereto. The method includes receiving, generating, storing, and transmitting steps. In the receiving step, at least one feed message from a mobile network is received, wherein the at least one feed message includes message content provided by an external party system and one or more sets of instructions. One or more message acknowledgments are generated, in the generating step, including any one of: a received message acknowledgment when the at least one feed message is received, a viewed message acknowledgment when the message content is displayed, and an operated message acknowledgment when the one or more sets of instructions are executed in accordance with one or more received input commands, or a combination thereof. The one or more message acknowledgments are stored in a memory in the storing step, and transmitted to a remote server in the transmitting step.

In yet another embodiment, a non-transitory computer readable storage medium stores a computer program for causing a computer to execute a method of receiving a feed message and transmitting information related thereto. The method comprises receiving, generating, storing and transmitting steps. In the receiving step, at least one feed message from a mobile network is received, wherein the at least one feed message includes message content provided by an external party system and one or more sets of instructions. One or more message acknowledgments are generated, in the generating step, including any one of: a received message acknowledgment when the at least one feed message is received, a viewed message acknowledgment when the message content is displayed, and an operated message acknowledgment when the one or more sets of instructions are executed in accordance with one or more received input commands, or a combination thereof. The one or more message acknowledgments are stored in a memory in storing step, and transmitted to a remote server in the transmitting step.

### BRIEF DESCRIPTION OF THE DRAWINGS

The features and advantages of the present invention will become more apparent from the detailed description set forth below when taken in conjunction with the following drawings.

FIG. 1 is an overview of a system for sending and receiving feed messages and information related thereto.

FIG. 2 is a block diagram of a mobile device.

FIG. 3 is a block diagram of a wallet server.

FIG. 4 is a sequence diagram illustrating the steps in creating a feed message.

FIG. 5 is a sequence diagram illustrating the steps in canceling a feed message.

FIG. 6 is a sequence diagram illustrating the steps in adding a message source.

FIG. 7 is a sequence diagram illustrating the steps in canceling a message source.

FIG. 8 is a sequence diagram illustrating the steps in generating a message delivery report.

FIG. 9 is a sequence diagram illustrating the steps in an initial subscription operation.

FIG. 10 is a sequence diagram illustrating the steps in getting new message sources.

FIG. 11 is a sequence diagram illustrating the steps in subscribing to one or more message sources.

FIG. 12 is a sequence diagram illustrating the steps in removing one or more message subscriptions.

FIG. 13 is a sequence diagram illustrating the steps in requesting and receiving new feed messages.

FIG. 14 is a flowchart illustrating the steps in a message retrieval operation.

FIG. 15 is a sequence diagram illustrating the steps in collecting and sending one or more message acknowledgments.

FIG. 16 is an exemplary view of a display screen of a mobile device.

FIG. 17 is an exemplary view of a display screen of a mobile device.

FIG. 18 is an exemplary view of a display screen of a mobile device.

FIG. 19 is an exemplary view of a display screen of a mobile device.

FIG. 20 is an exemplary view of a display screen of a mobile device.

FIG. 21A is an exemplary view of a display screen of a mobile device being controlled by a gesture command.

FIG. 21B is an exemplary view of a display screen of a mobile device running a program in response to the gesture command shown in FIG. 21A.

FIG. 22A is an exemplary view of a display screen of a mobile device being controlled by a gesture command.

FIG. 22B is an exemplary view of a display screen of a mobile device running a program in response to the gesture command shown in FIG. 22A.

FIG. 23 is a block diagram of a general and/or special purpose computer.

### DETAILED DESCRIPTION

### System Overview

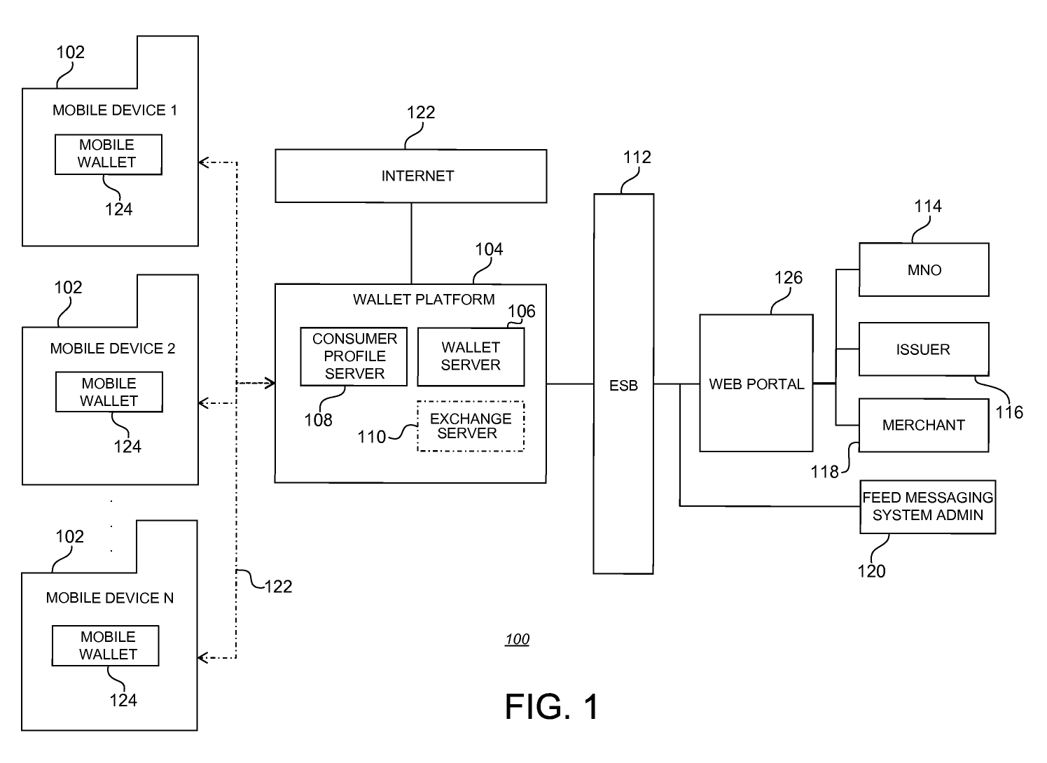

FIG. 1 is an overview of a feed messaging system 100 for providing feed messages to mobile device. The feed messaging system 100 includes a mobile device 102 (mobile device 1, mobile device 2, . . . , mobile device N) communicatively coupled to a wallet platform 104. The wallet platform 104 includes a mobile wallet server 106 (referred to herein as “wallet server”) and a consumer profile server 108. In another embodiment, the wallet platform 104 also includes an exchange server 110 designed to facilitate communication between the mobile device 102 and external parties. The wallet platform 104 is connected to an Enterprise Service Bus (ESB) 112 which acts as an intermediary between the wallet platform 104 and external party systems. External parties may include any entity other than the user of the mobile device 102. Most often, the external parties utilizing the feed messaging system will be service providers. A service provider (SP) is a company, organization, entity, or the like, that provides products and services to the user. Examples of service providers include account-issuing entities such as banks, merchants, card associations, marketing companies, and transit authorities. FIG. 1 illustrates three such classes of service providers: mobile network operators (MNO) 114, issuers 116, and merchants 118. An MNO 114 is a company or organization that runs the mobile network 122 over which the mobile device 102 communicates. An Issuer 116 is an entity that is associated with a digital item stored on the mobile device 102, as discussed below. A Merchant 118 is a provider of goods or services to the user. Each of these features will be described in more detail below.

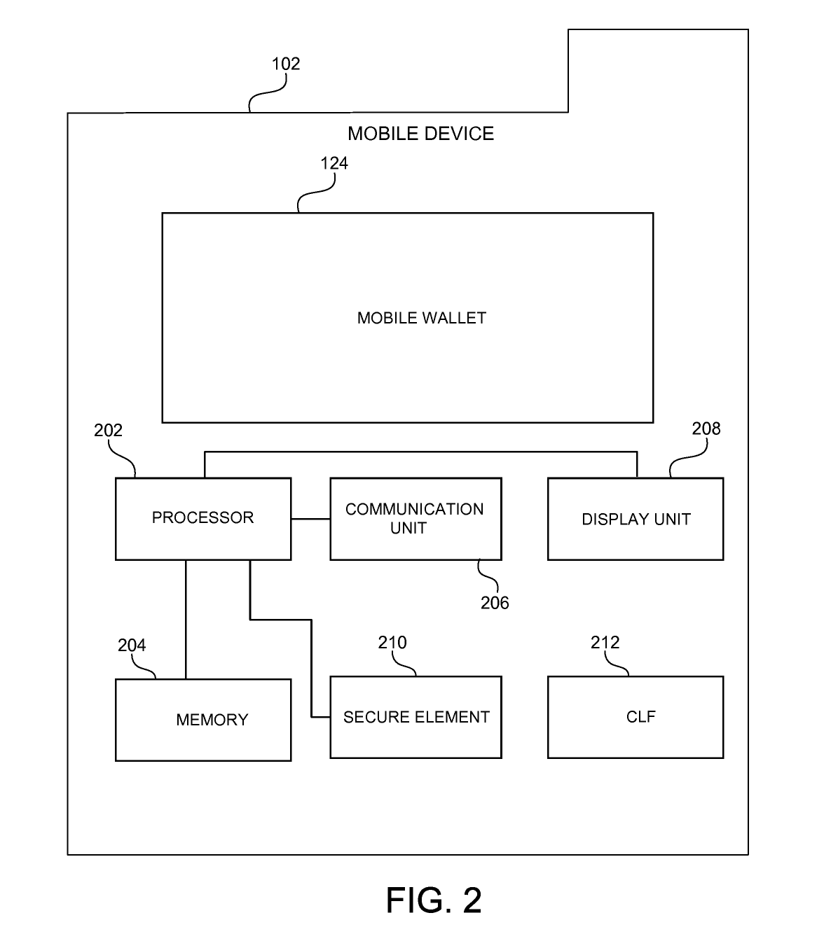

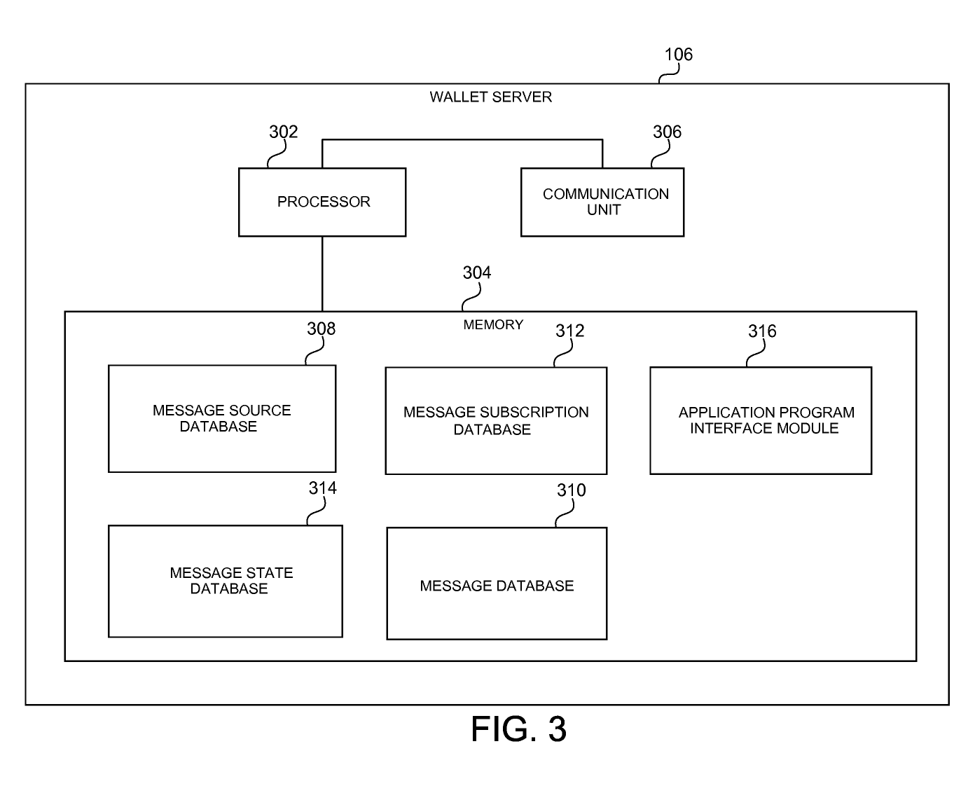

As shown in FIG. 2, the mobile device 102 includes a processor 202, a memory 204, a communication unit 206, and a display unit 208, and may also include a secure element 210 and a Contactless Front (CLF) 212. Stored in the memory 204 is a mobile wallet 124 application (hereinafter “mobile wallet”) which is a set of program codes which, when executed by the processor 202, causes the mobile device 102 to perform the functions described herein. A user of the mobile device 102 may interact with the mobile device 102 via an input unit (not shown) or the display unit 208. The input unit may be, for example, a keyboard, touch sensitive area, one or more buttons, or an electronic writing surface included in the mobile device 102. The input unit may also be an input/output port which connects to an external device via which the user can send commands to the mobile device 102. In conjunction with the input unit, or as an alternative means of controlling the mobile device 102, the user may interact with the display unit 208. To facilitate such interaction, the display unit 208 may be a touch sensitive screen.

The mobile wallet 124 allows a user to conduct transactions using the mobile device 102. These transactions may be, for example, contactless transactions at a point of sale (POS) (or “check-out”) terminal. To facilitate these transactions, the mobile device 102 is configured to store various pieces of information including digital instruments such as, for example, credit, offer, and loyalty card information. This information may be stored in the secure element 210, which is provided with security measures to prevent unauthorized access of the user's information, such as data encryption. The user may interact with the mobile wallet 124 via the input unit or the display unit 208, as described above.

The CLF 212 allows the mobile device 102 to communicate with nearby devices, such as a Near Field Communications (NFC) chip or a contactless reader, without physically connecting to the device via, e.g., a wire. The mobile wallet 124 controls the operation of the mobile device hardware, including the CLF 212, the secure element 210 and the communication unit 206 in order to conduct the contactless transactions. To execute a transaction, a user simply has to bring the mobile device 102 within range of the object to which communication is desired (not shown) so that the CLF 212, the secure element 210, and the communication unit 206 may operate to effectuate the transaction. The mobile device 102 may communicate using the International Standards Organization (ISO) 7816 commands and NFC ISO 14443 protocol.

The communication unit 206 allows the mobile device 102 to wirelessly connect to an external object or device. The communication unit 206 may be configured to connect to a wireless local area network (WLAN), e.g. a WLAN based on, for example, the Institute of Electrical and Electronics Engineers (IEEE) 802.11 standards, i.e. “Wi-Fi,” or other types of communication networks such as a cellular data network or mobile satellite communications. With respect to the latter two categories, the specific type of wireless communication network may be dictated by the type of network the MNO 114 operates. In that regard, the communication unit 206 may contain one module, or radio, to communicate over one or more communication networks, or include multiple modules which communicate over multiple communication networks. In addition, the mobile device 102 may be configured to include a wired communication unit, e.g. an Ethernet unit, which allows the mobile device 102 to communicate with external devices. The wired communication unit is communicatively connected to an auxiliary input such as, for example, a Universal Serial Bus (USB) connection, mini-USB connection, micro-USB connection, Firewire connection, Lightning connection, or the like.

The memory 204 may store one or more applets, applications, or commerce widgets (collectively referred to as “commerce widgets” hereinafter), which are program instructions for executing one or more operations associated with a service provider. A commerce widget may be associated with one or more digital instruments (e.g., a credit card, payment/loyalty card, coupon, and/or offers) stored in the memory 204 or the secure element 210, and used by the mobile wallet 102 to execute corresponding transactions or enable a user to interact in a manner provided by the service provider. If a commerce widget is stored on the secure element 210, then the mobile wallet 102 is configured to communicate with the secure element 210 to access and use the commerce widgets stored therein. The memory 204 stores feed messages received from the wallet server 106. As will be discussed further below, the feed messages are tied to the mobile wallet 124 and are displayed therein. Therefore, to a user of the mobile device 102 the received feed messages appear stored in the mobile wallet 124. The feed messages can, therefore, be considered to be delivered to the mobile wallet 124 and stored therein.

As noted above, the mobile device 102 communicates with the wallet platform 104. The wallet platform 104 includes the wallet server 106 which is external to the mobile device 102 and constructed to manage the mobile wallet 124. The wallet server 106 includes a processor 302, memory 304, and a communication unit 306. The wallet server memory 304 contains program instructions which, when executed by the processor 302, cause the wallet server 106 to perform the functions described herein. The wallet server 106 can modify the contents of the mobile wallet 124 and can also add additional commerce widgets to the mobile device 102. The wallet server 106 also functions to handle communications between the mobile device 102 and external parties, such as the service provider systems 114, 116, and 118 shown in FIG. 1. In another embodiment, communications between external parties and the wallet platform 104 are managed by an exchange server 110, as opposed to the wallet server 106. The wallet platform 104 also includes a consumer profile server 108 which is constructed to create, update, and store a consumer profile corresponding to the user of the mobile wallet 102. The consumer profile server 108 may be accessible via the Internet 122 to allow a feed system person, or an external party, such as a service provider to access the data stored therein. In another embodiment, the functionalities of the consumer profile server 108 may be included in the wallet server 106.

As will be discussed in further detail below, the wallet server 106 also stores feed messages from the service provider systems 114, 116, and 118 prior to delivering the feed messages to the mobile wallet 124. The wallet server 106 may also be accessed by a user via the Internet 122, thereby allowing the user to read, interact with, or delete feed messages which are awaiting delivery to their mobile wallet 124. The wallet server 106 also tracks the state of the feed message on the mobile wallet 124.

The ESB 112 systems manage interactions between external parties, such as the service provider systems 114, 116, and 118, and the mobile device 102, and provides the service provider systems 114, 116, and 118 a mechanism to efficiently and securely communicate with the mobile device 102, without the need to directly connect to it. Thus, in a system where a plurality of mobile devices are present and desired to be communicated with, the ESB 112 provides an efficient portal for the service provider. As noted above, FIG. 1 shows three types of service providers: MNO 114, Issuers 116, and Merchants 118 connected to the ESB 112. Each of these service providers 114, 116, and 118 constitutes one or more message sources. In addition, the feed message system administrator 120 generates feed messages related to basic actions taken by the user when they interact with their mobile wallet 124 or related to the feed messaging system 100 itself, such as service interruptions.

### Wallet Server Database Design

As noted above, the wallet server 106 includes a memory 304 which is configured to store a plurality of databases which respectively store entries corresponding to: each message source which participates in the feed messaging system 100 (wallet server message source database 308), messages generated by the message sources (wallet server message database 310), message subscriptions corresponding to the mobile wallet 124 (wallet server message subscription database 312), and message states of feed messages destined for the mobile wallet 124 (wallet server message state database 314). The memory 304 also stores an Application Program Interface (API) module 316.

The wallet server message source database 308 stores a plurality of entries corresponding to each message source which participates in the feed messaging system 100. As shown in Table 1 below, each entry in the wallet server message source database 308 is a table comprised of a plurality of fields which serve to identify the message source. Each of these fields will be discussed in detail below.

TABLE 1
Wallet Server Message Source Database Table

| No. | Field | Description |
|---|---|---|
| T100 | Message | Primary identification of the message source on the feed |
| | Source ID | messaging system. |
| T102 | Message | Indicates whether the message source is active or not |
| | Source Status | (Active/Discontinued). |
| T104 | Message | Indicates the type of message source (Feed Messaging |
| | Source Type | System Administrator, MNO, Issuer, or Merchant). |
| T106 | Message | Indicates whether the message source is one which the |
| | Source Nature | mobile wallet automatically subscribes to when the mobile |
| | | wallet is activated or is subscribable to at a later time. |
| | | (Mandatory/Default/Optional). |
| T108 | Message | Indicates the name of the message source. |
| | Source Name | |
| T110 | Message | Provides a brief description of the message source. |
| | Source | |
| | Description | |
| T112 | Full Logo | Image corresponding to the message source which is used |
| | | as a logo for an activity log type feed message. |
| T114 | Partial Logo | Image corresponding to the message source which is to be |
| | | used as a logo for a notification or an offer type feed |
| | | message. |

When a new message source is added to the feed messaging system 100, the feed messaging system 100 automatically assigns the message source a message source ID T100. Once a message source is added to the wallet server message source database 308, the message source takes on a status of active or discontinued in accordance with instructions provided by the service provider system 114, 116, and 118. The service provider system 114, 116, and 118 may have a plurality of message sources stored in the wallet server message source database 308 with some being active while others are inactive. Thus, the service provider systems 114, 116, and 118 may communicate with the wallet server 106 via the web portal 126 to change the status of a given message source from active to discontinued, or vice versa.

The “Message Source Type” field T104 denotes the type of message source, i.e., whether the source of the messages is a merchant, issuer, MNO, or the feed messaging system 100. The “Message Source Nature” field T106 stores a value indicating whether the message source is categorized as mandatory, default, or optional. Mandatory message sources are automatically subscribed to when the mobile wallet 124 is activated, and cannot later be unsubscribed from. Default message sources are also automatically subscribed to when the mobile wallet 124 is activated, but may later be unsubscribed to by the user. Optional message sources are not automatically subscribed from when the mobile wallet 124 is activated, but may be subscribed to, as discussed below, at a later time by the user. The “Message Source Name” field T108 stores a value which identifies the service provider 114, 116, and/or 118 associated with the message source. For example, if the message source is associated with a bank named “Acme Federal Credit Union” then this field would be populated with “Acme Federal Credit Union.” The “Message Source Description” field T110 provides a description of the message source, or the service provider to which it is associated. The “Full Logo” field T112 is populated with a full size image associated with the message source and is displayed with an “activity log” type feed message. The “Partial Logo” field T114 is populated with a smaller image of the logo associated with the message source and is displayed when the feed message type is a notification or an offer, as will be discussed below.

Once the mobile wallet 124 is activated on the feed messaging system 100, the user may subscribe to various message sources provided by the service provider systems 114, 116, and 118. When the user of the mobile wallet 124 subscribes to a message source, the subscription is recorded in the wallet server message subscription database 312. As shown in Table 2 below, each entry in the wallet server message subscription database 312 is a table with a plurality of fields.

TABLE 2
Wallet Server Message Subscription Database Table

| No. | Column | Description |
|---|---|---|
| T200 | Message | Primary identification of the message |
| | Subscription ID | subscription on the feed messaging system. |
| T202 | Message | Indicates whether the message subscription is |
| | Subscription | presently active or not (Active/Discontinued) |
| | Status | |
| T204 | Message Source | Indicates the name of the message source. |
| | Name | |
| T206 | Message Source | Unique reference identification of the message |
| | External | source on the external parties system. |
| | Reference ID | |
| T208 | Wallet ID | Unique identification of the mobile wallet. |
| T210 | Creation | Date/Time when the message subscription was |
| | Time Stamp | generated by the user. |
| T212 | Discontinue Time | Date/Time when the message subscription was |
| | Stamp | discontinued by the user. |

The “Message Subscription ID” field T200 is a unique identification generated by the feed messaging system 100 once the message subscription is generated. The “Message Subscription Status” field T202 indicates whether the subscription is presently active or discontinued. While a user may unsubscribe from default and optional message sources at any time, the wallet server 106 maintains a record of those message subscriptions in the wallet server message subscription database 312. As will be discussed below, this information is relevant to a consumer profile of the user. The “Message Source Name” field T204 is populated with the name of the entity associated with the message source. Like above, if the message source for a given message subscription is “Acme Federal Credit Union,” this field would be populated with “Acme Federal Credit Union.” The “Wallet ID” field T208 is populated with the specific identification assigned to the mobile wallet 124 when the mobile wallet 124 is activated. The “Creation Time Stamp Field” field T210 is populated with the date (and optionally the time) on which the message subscription is generated. The “Discontinue Time Stamp” field T212 is populated with the date (and optionally the time) on which the message subscription is cancelled. Of course, if the message subscription is not discontinued, then this field would remain unpopulated.

As described above, the feed messaging system 100 is designed to deliver feed messages to the mobile wallet 124. A feed message is a communication from an external party to the user via the mobile wallet 124. The feed message contains text information, but may also contain images and program code as well. The feed message may be a notification, an offer, or activity log. In general, a notification is distinguished from an offer or an activity log, because it contains information of an event external to the operation of the feed messaging system 100 which is not an offer to purchase an item. As an example, a notification feed message may be a notice of a balance in a checking account. An offer is an inducement to the user to engage in commerce, e.g., a coupon for the purchase of an item. An activity log message notifies the user of an activity related to the mobile wallet 124, e.g. notification that a purchase has been completed.

When a service provider system 114, 116, or 118 calls an API to create a feed message, a corresponding feed message is generated in the wallet server 106 in accordance with the information provided thereto, and stored in the wallet server message database 310. As shown in Table 3, each entry in the wallet server message database 310 is a table comprising a plurality of fields populated with corresponding values that comprise the feed message.

TABLE 3
Wallet Server Message Database Table

| No. | Column | Description |
|---|---|---|
| T300 | Message ID | Unique identification value of the feed message on the |
| | | feed messaging system. |
| T302 | Message Status | Status of the feed message |
| | | (Active/Discontinued/Expired). |
| T304 | Message Type | Feed message type (Notification/Offer/Activity Log) |
| T306 | Message Source | Indicates the name of the message source |
| | Name | |
| T308 | Message Source | Unique identification of the message source on the feed |
| | ID | messaging system. |
| T310 | Message External | Unique identification value of the feed message on an |
| | Reference ID | external parties' system. |
| T312 | Message Body | Body content of the feed message |
| T314 | Creation Time | Date/Time when the feed message is generated. |
| | Stamp | |
| T316 | Expiration Time | Date/Time when the feed message is set to expire |
| | Stamp | |
| T318 | Scheduled | Date/Time when the feed message is scheduled to be |
| | Delivery Time | delivered. |
| | Stamp | |
| T320 | Message Logo | Action identification associated with the logo (e.g., call |
| | Action ID | telephone number, load commerce widget, open link) |
| T322 | Logo Action | Programming instructions associated with the logo. |
| | Parameters | |
| T324 | Body Action ID | Action identification associated with the body of the |
| | | feed message |
| T326 | Body Action | Programming instructions associated with the body of |
| | Parameter | the message |
| T328 | Full Logo | Image to be used as a full logo |
| T330 | Partial Logo | Image to be used as a partial logo |

As shown in Table 3, each feed message is assigned a unique message ID T300 by the feed message system 100 when generated. The “Message Status” field T302 indicates whether the feed message is presently active, discontinued, or expired. As noted above, the feed message can be an offer, which the service provider can discontinue or set to expire after a certain period of time. If the service provider chooses an expiration time, then that value is entered into the “Expiration Time Stamp” field T316. To discontinue the offer the service provider system 114, 116, and 118 may use the web portal 126 and the ESB 112 interacts with the wallet server 106 and the changes the value in the “Message Status” field to discontinued. As previously discussed, the feed message may correspond to a notification, offer, or an activity log, and the value in the “Message Type” field T304 is entered accordingly. The name of the message source (or service provider who sent the message) is entered in the “Message Source Name” field T306. The “Message Source ID” field T308 is populated by a value corresponding to the message source's ID on the feed messaging system 100. The “Message External Reference ID” field T310 allows for the service provider sending the feed message to provide a reference identification value for their internal system.

The “Message Body” field T312 is where the body of the message that is being sent is entered. The body is typically a block of text written and entered by the service provider corresponding to the message source. The maximum length of a string of characters and spaces which can be entered in the “Message Body” field is predetermined by the feed messaging system administrator. While the maximum string length could be any number, in one embodiment the maximum is set to 134. One of the advantages of limiting the string length to 134 characters, is that the user is not overwhelmed by the amount of information being presented. As a result, there is a greater likelihood that the feed message will be read, and possibly acted upon.

A service provider may choose to have its feed message delivered immediately, or the service provider can designate a certain time for the feed message to be delivered by entering an appropriate value in the “Scheduled Delivery Time Stamp” field T318. This allows the service provider to create and store a feed message on the wallet server 106 at a convenient time, and then have the message delivered at a later time.

In one embodiment, the mobile device 102 performs a wide array of functions including, for example, making a telephone call, opening a commerce widget stored in the secure element 210 or the memory 204, or opening a web browser and loading a webpage. The “Message Logo Action ID” T320 field is populated with an action ID corresponding to a desired action. For example, if the service provider system 114, 116, and 118 would like a commerce widget stored on the mobile device 102 to be opened and run when the body of the message is clicked, this field is populated with the value “Load Commerce Widget.” If the service provider would like the mobile device 102 to dial a specific telephone number or open a web browser and load a specific webpage, the field is populated with the values “Call Number” and “Open Link,” respectively.

Of course, each of these actions requires specific programming for their respective executions. Accordingly, the “Body Action Parameter” field T326 is populated with the specific set of instructions or parameters which, when executed by the processor 102 in conjunction with the memory 204, cause the corresponding action identified in the “Body Action ID” field T324 to be performed. The service provider system 114, 116, and 118 provides these parameters or instructions when the feed message is generated.

The service provider system 114, 116, and 118 may also configure the feed message to display a full or partial logo, which corresponds to the service provider, when the message is displayed on the display unit 208 of the mobile device 102. Whether a full logo or a partial logo is displayed may be set corresponding to the type of message. For example, if the value in the “Message Type” field T304 is “Activity Log,” then a full logo is displayed, as opposed to a partial logo if the value in the “Message Type” T304 field is either “Offer” or “Notification.”

The wallet server 106 also includes a Mobile Wallet Message State database 314 which tracks the relationship between the mobile wallet 124 and the feed message. As shown in Table 4, each entry in the Mobile Wallet Message State 314 database is a table comprising a plurality of fields.

TABLE 4
Mobile Wallet Message State Database Table

| No. | Column | Description |
|---|---|---|
| T400 | Wallet Message State | Unique identification value of the feed message on |
| | ID | the feed messaging system. |
| T410 | Message External | Unique identification value of the feed message on |
| | Reference ID | an external parties' system. |
| T420 | Message Status | Status of the feed message (sent for delivery, |
| | | delivered, viewed, operated). |
| T430 | Wallet ID | Unique identification of the mobile wallet. |
| T440 | Delivery Time Stamp | Date/Time when the feed message is delivered. |
| T450 | View Time Stamp | Date/Time when the feed message is viewed. |
| T460 | Operation Time | Date/Time when an operation programmed into |
| | Stamp | the feed message executed. |

The “Wallet Message State ID” field T400 is populated with a value that is automatically generated by the wallet server 106 once the feed message is delivered to the mobile device 102. The “Message External Reference ID” field 410 is populated with the service provider's message ID of the feed message that is delivered to the mobile device 102, i.e., the value in the Message External Reference ID field T310 in the Wallet Server Message Database Table (Table 3). The “Message Status” field T420 indicates the status of the feed message on the mobile device 102. There are four possible values for this field: sent for delivery, delivered, viewed, and operated. Sent for delivery means that the feed message has been sent from the wallet server 106 to the mobile device 102, but the wallet server 106 has not yet received confirmation that the feed message has been delivered. Upon receiving such confirmation, this value is changed to “delivered.” If and when the user elects to view the feed message, the value is changed from “delivered” to “viewed,” when the mobile device 102 next synchronizes with the wallet server 106. If the user elects to execute an action contained within the feed message, such as the “Body Action,” then this value is changed from “viewed” to “operated” when the mobile device 102 next synchronizes with the wallet server 106. Time stamps corresponding to when the feed message is delivered, viewed (if at all), and operated (if at all), are stored in the respective “Delivery Time Stamp” field T440, “View Time Stamp” T450, and “Operation Time Stamp” field T460.

### Mobile Wallet Database Design

The mobile device 102 on which the mobile wallet 124 operates is also configured to include a plurality of databases in the secure element 210 or in the memory 204, including a Mobile Wallet Message Source Database and a Mobile Wallet Message Database. Each entry in the Mobile Wallet Message Source Database is a table with a plurality of entries as shown and described below in Table 5.

TABLE 5
Mobile Wallet Message Source Database Table

| No. | Column | Description |
|---|---|---|
| T500 | Message | Unique identification of the feed message |
| | Source ID | source on the feed messaging system. |
| T510 | Message | Indicates whether the message source is active or not |
| | Source | (Active/Discontinued). |
| | Status | |
| T520 | Message | Indicates whether the message source generates |
| | Source | messages which are automatically sent to a mobile |
| | Nature | device or must be subscribed to first |
| | | (Mandatory/Default/Optional). |
| T530 | Message | Indicates the name of the message source. |
| | Source | |
| | Name | |
| T540 | Full Logo | Image corresponding to the message source which |
| | | is used as a logo for an activity log. |

The fields for each entry in the Mobile Wallet Message Source Database are the same as those in the Wallet Server Message Source database on the wallet server 106, shown in Table 1 and described above.

TABLE 6
Mobile Wallet Message Database

| No. | Column | Description |
|---|---|---|
| T605 | Message ID | Unique identification value of the feed message on the feed |
| | | messaging system. |
| T610 | Message Type | Type of feed message (Notification, Offer, Activity |
| | | Log) |
| T615 | Message Status | Status of the feed message: |
| | | (Active/Discontinued/Expired) |
| T620 | Message Source | Indicates the name of the message source. |
| | Name | |
| T625 | Message Body | Body content of the feed message. |
| T630 | Message | Date/Time when the feed message is downloaded from |
| | Download | the wallet server 106. |
| | Timestamp | |
| T635 | Message Logo | Action identification associated with the logo (e.g., |
| | Action ID | call number, load commerce widget, open link). |
| T640 | Logo Action | Programming instructions associated with the logo. |
| | Parameters | |
| T645 | Body Action ID | Action identification associated with the body of the |
| | | feed message. |
| T650 | Body Action | Programming instructions associated with the body of |
| | Parameters | the message. |
| T655 | Full Logo | Image to be used as a full logo. |
| T660 | Partial Logo | Image to be used as a partial logo. |

Each feed message received by the mobile wallet 124 is stored in a database on the mobile device 104, with each entry in the database being a table populated by the fields shown in Table 6. The fields shown in Table 6 are substantially the same as those shown in Table 3, with the exception of the field designated “Message Download Timestamp” field T630 which is populated with a value corresponding to when the feed message is downloaded to the mobile wallet 124. The values in the Mobile Wallet Message Database may be updated based upon events which occur or the passage of time. For instance, if the feed message is set to expire after a certain period of time, then once that period elapses the “Message Status” field T615 is updated to reflect that the feed message has expired, the next time the mobile wallet 124 synchronizes with the wallet server 106.

### Service Provider System Interaction

As noted above, service provider systems 114, 116, and 118 interact with the feed messaging system via the web portal 126. The web portal 126 allows the service provider systems 114, 116, and 118 to call various Application Program Interfaces (API), shown below in Table 7, which are stored on the wallet server 106.

TABLE 7
Application Program Interfaces Exposed to the Service Providers

| | Application Program | |
|---|---|---|
| No. | Interface (API) | Description |
| T710 | Create Message | Allows a service provider to create a feed |
| | | message. |
| T720 | Cancel Message | Allows a service provider to cancel an |
| | | existing feed message. |
| T730 | Add Message Source | Allows a service provider to add a new |
| | | message source. |
| T740 | Cancel Message | Allows a service provider to cancel an |
| | Source | existing message source. |
| T750 | Message Delivery | Allows a service provider to get a feed |
| | Report | message delivery report. |

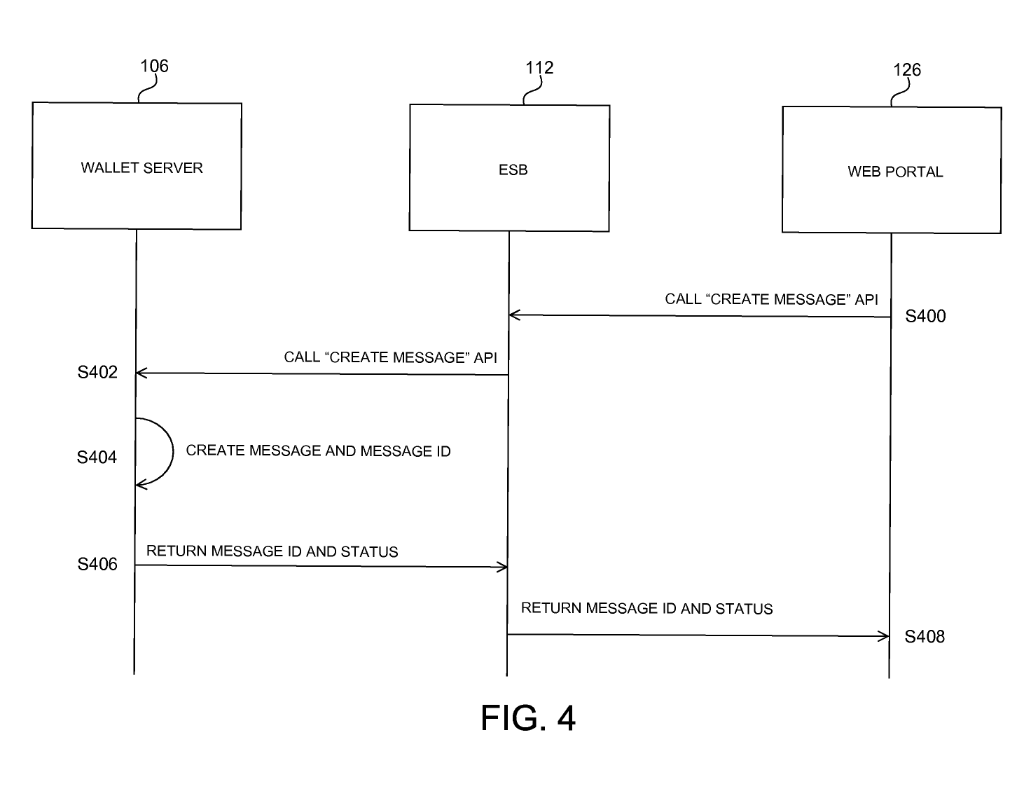

As shown in FIG. 4, to create a new message on the feed messaging system, a service provider system 114, 116, and 118 calls the “Create Message” API T710 exposed by the wallet server 106 via the ESB 112 in steps S400 and S402. The service provider system 114, 116, and 118 provides the required information to complete the create message function. As shown in Table 8 below, in one embodiment certain elements are required, while others are optional.

TABLE 8
Create Message Operation Elements

| No. | Column | Description | Required |
|---|---|---|---|
| T800 | External | Unique identification value of the feed | No |
| | Reference ID | message on an external parties' system. | |
| T805 | Message Type | Type of Message (Notification, Offer, or | Yes |
| | | Activity Log). | |
| T810 | Message Source | Indicates the name of the message source. | Yes |
| | Name | | |
| T815 | Message Body | Body content of the feed message. | Yes |
| T820 | Expiration Time | Date/Time at which the feed message | No |
| | Stamp | expires. | |
| T825 | Scheduled | Date/Time when the feed message is | No |
| | Delivery Time | scheduled to be delivered. | |
| | Stamp | | |
| T830 | Message Logo | Action identification associated with the | No |
| | Action ID | logo (e.g., call number, load commerce | |
| | | widget, open link). | |
| T835 | Logo Action | Programming instructions associated with | No |
| | Parameters | the logo. | |
| T840 | Body Action ID | Action identification associated with the | No |
| | | body of the feed message. | |
| T845 | Body Action | Programming instructions associated with | No |
| | Parameters | the body of the message. | |
| T850 | Full Logo | Image to be used as a full logo. | No |
| T855 | Full Logo URL | URL of the logo hosted on a content | No |
| | | system. | |
| T860 | Partial Logo | Image to be used as a partial logo. | No |
| T865 | Partial Logo URL | URL of the logo hosted on a content system. | No |

As indicated in Table 10, the service provider system 114, 116, and 118 need only provide the message type, message source name, and the body of the message to create a new feed message. The remaining fields shown in Table 10 are optional. In step S404, the wallet server 106 creates the new feed message and assigns it a message ID. The wallet server 106 then returns the message ID and the operation status to the service provider via the ESB 112, in steps S406 and S408. The operation status indicates whether the feed message was generated successfully. If the wallet server 106 fails to create the feed message, then instead of the message ID, the wallet server 106 will return an error code corresponding to the error along with the operation status. The wallet server 106 stores a database of error codes, shown in Table 9, and generates the appropriate error code based on an automated analysis.

TABLE 9
Error Type/Messages Database

| Error | | |
|---|---|---|
| Code | Error | Error Description |
| T900 | SYSTEM | SYSTEM EXCEPTION OCCURRED |
| | EXCEPTION | |
| T905 | BUSINESS | FAILED TO CREATE MESSAGE |
| | EXCEPTION | |
| T910 | BUSINESS | FAILED TO CANCEL MESSAGE |
| | EXCEPTION | |
| T915 | BUSINESS | MESSAGE SOURCE NOT FOUND |
| | EXCEPTION | |
| T920 | BUSINESS | INVALID MESSAGE TYPE |
| | EXCEPTION | |
| T925 | BUSINESS | INVALID MESSAGE SOURCE TYPE |
| | EXCEPTION | |
| T930 | BUSINESS | INVALID SOURCE NATURE |
| | EXCEPTION | |
| T935 | BUSINESS | INVALID LOGO ACTION ID |
| | EXCEPTION | |
| T940 | BUSINESS | INVALID BODY ACTION ID |
| | EXCEPTION | |
| T945 | BUSINESS | DUPLICATE MESSAGE SOURCE |
| | EXCEPTION | |
| T950 | BUSINESS | INVALID MESSAGE EXPIRY DATE |
| | EXCEPTION | |
| T955 | BUSINESS | INVALID MESSAGE DELIVERY DATE |
| | EXCEPTION | |
| T960 | BUSINESS | MESSAGE SOURCE DISCONTINUED |
| | EXCEPTION | |
| T965 | BUSINESS | MESSAGE NOT FOUND |
| | EXCEPTION | |
| T970 | BUSINESS | INVALID FULL LOGO SOURCE |
| | EXCEPTION | |
| T975 | BUSINESS | INVALID PARTIAL LOGO SOURCE |
| | EXCEPTION | |
| T980 | BUSINESS | WALLET ID NOT FOUND |
| | EXCEPTION | |

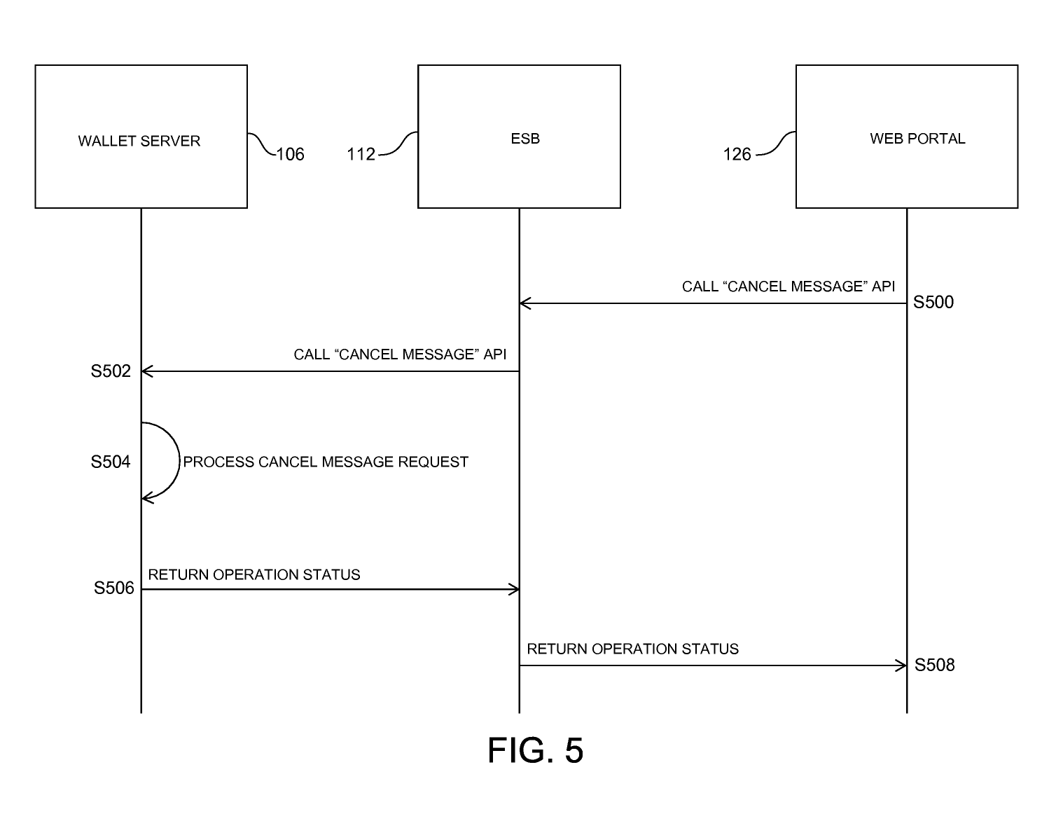

FIG. 5 is a sequence diagram showing the steps involved in cancelling an existing feed message that is stored on the wallet server 106. The service provider system 114, 116, and 118 calls the “Cancel Message” API T720 exposed by the wallet server 106 via the ESB 112, in steps S500 and S502, and provides the message ID for the feed message to be cancelled. The service provider system 114, 116, and 118 may optionally provide the external reference ID, corresponding to the service provider's system 114, 116, and 118. The wallet server 106 then processes the cancel message operation, and returns an operation status message to the service provider system 114, 116, and 118 via the ESB 112 indicating whether the cancel message operation was completed successfully. If the cancel message operation was not completed successfully, then the wallet server 106 returns an error code from Table 9 which is generated after the wallet server 106 conducts an internal error analysis.

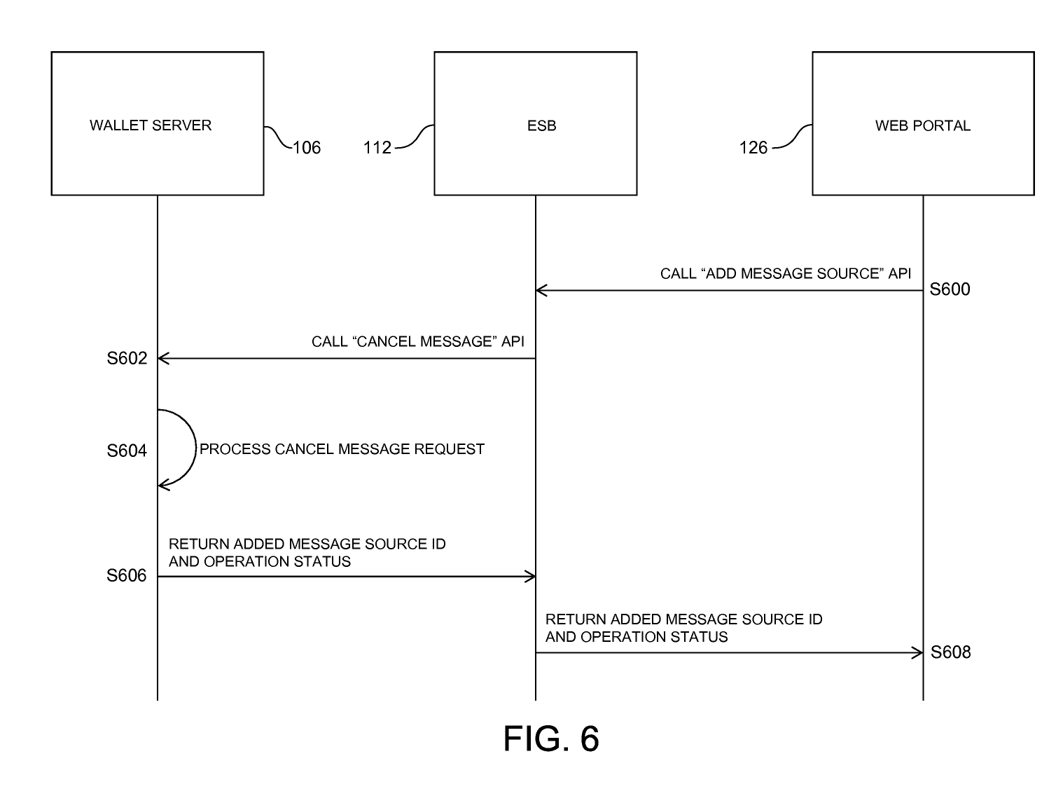

FIG. 6 is a sequence diagram showing the steps involved in adding a message source to the wallet server 106. The service provider calls the “Add Message Source” API T730 exposed by the wallet server 106 via the ESB 112, in steps S600 and S602, and provides the required details of the message source to be added, as shown in Table 10 below. Each of the fields shown in Table 10 has been previously discussed above.

TABLE 10
Add Message Source Elements

| No. | Field | Description | Required? |
|---|---|---|---|
| T1000 | Message | Unique identification of the message source. | Yes |
| | Source Name | | |
| T1010 | Message | Unique identification of the message source | Yes |
| | Source | on the service provider's system. | |
| | External | | |
| | Reference ID | | |
| T1020 | Message | Indicates the type of message source (Feed | Yes |
| | Source Type | Messaging System Admin, MNO, Issuer, or | |
| | | Merchant). | |
| T1030 | Message | Indicates whether the message source | Yes |
| | Source Nature | generates messages which are automatically | |
| | | sent to a mobile device or must be | |
| | | subscribed to first | |
| | | (Mandatory/Default/Optional). | |
| T1040 | Message | Provides a brief description of the message | No |
| | Source | source. | |
| | Description | | |
| T1050 | Full Logo | Image to be used as logo. | No |

In S604 the wallet server 106 processes the add message source request and, if the request is successfully executed, returns the Message Source ID of the generated message source and an operation status indicating that the operation was a success. If, however, an error occurs, the mobile wallet 124 returns an operation status indicating that the message source was not successfully added and a corresponding error code generated by an internal analysis conducted by the wallet server 106.

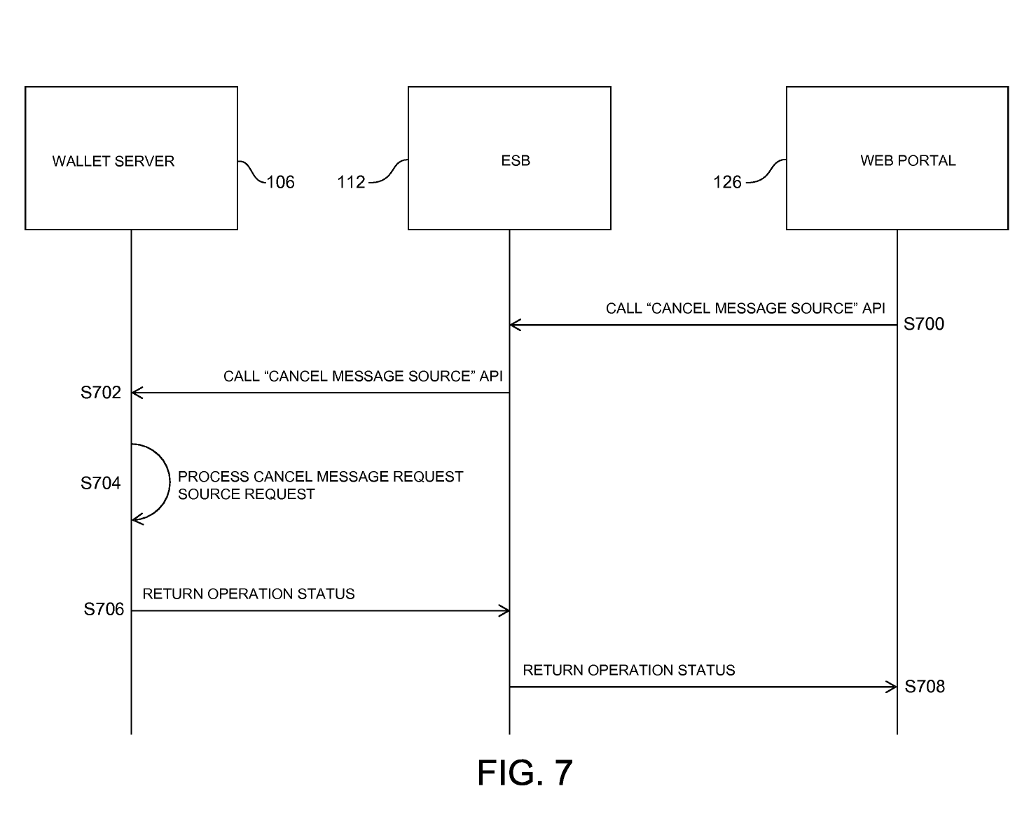

FIG. 7 is a sequence diagram showing the steps involved in canceling a message source. The service provider calls the “Cancel Message Source” API T740 exposed by the wallet server 106 via the ESB 112 in steps S700 and S702. Along with the request, the service provider system 114, 116, and 118 provides the Message Source Name and Message Source ID of the message source which is to be cancelled. In step S704, the wallet server 106 processes the cancel message source request, and returns an operation status message to the service provider system 114, 116, and 118 via the ESB 112, in steps S706 and S708 indicating whether the operation was successful or not. If the operation was not successful, then the wallet server 106 conducts an internal error analysis and returns an error message, from Table 9, notifying the service provider system 114, 116, and 118 of the error that occurred.

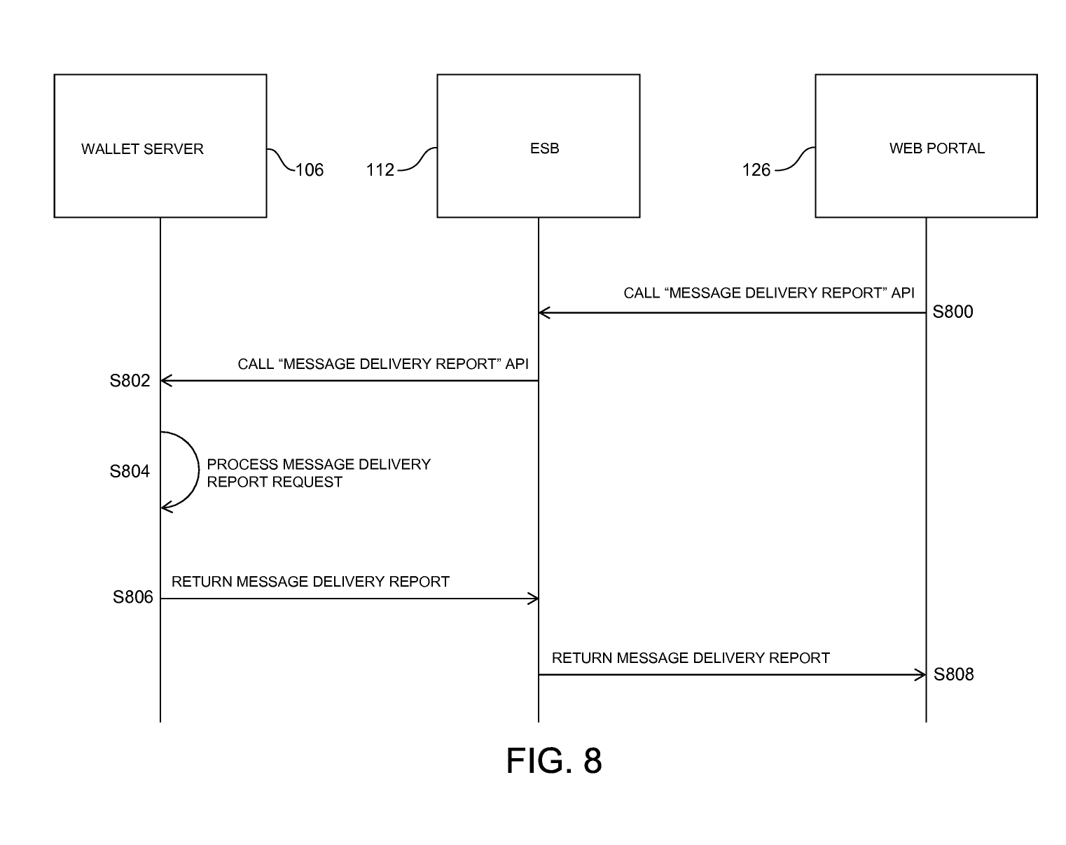

FIG. 8 is a sequence diagram showing the steps involved in generating a Message Delivery Report. The “Message Delivery Report” API T750 allows the service provider systems 114, 116, and 118 to retrieve status change records of a previously published feed message. The operation, if successfully executed, returns a set of message delivery logs for the specified feed message. The service provider systems 114, 116, and 118 call the “Message Delivery Report” API T750 exposed by the wallet server 106 via the ESB 112, in steps S800 and S802. Along with the request in step S800, the service provider also includes the Message Source Name and the Message ID of the feed message to which the report pertains. The service provider may also, optionally, include the Message External Reference ID. The wallet server 106 processes the request and generates a Message Delivery Report, in S804, based upon information stored in one or more of the Message State Database 314, the Message Subscription Database 312, the Message Source Database 308, and the Message Database 310. As shown below in Table 11, the Message Delivery Report contains a plurality of fields.

TABLE 11
Message Delivery Report

| No. | Field | Description | Required? |
|---|---|---|---|
| T1100 | Mobile Wallet | Unique identification of the | Yes |
| | ID | mobile wallet. | |
| T1110 | Message Status | Status of the message (Not | Yes |
| | | Delivered, Sent for Delivery, | |
| | | Delivered, View, Operated). | |
| T1120 | Delivery Time | Date/Time on which the wallet | No |
| | Stamp | downloaded the message. | |
| T1130 | View Time | Date/Time on which the user | No |
| | Stamp | viewed the feed message | |
| | | on the mobile wallet. | |
| T1140 | Operation | Date/Time on which the user | No |
| | Time Stamp | operated on the message. | |

As shown in Table 11, the Message Delivery Report includes the unique identification of the mobile wallet 124 to which the feed message is destined, in addition to the present status of the message. As discussed above, the feed message may be in one of five possible states: Not Delivered, Sent for Delivery, Delivered, View, and Operated. Additionally, the Message Delivery Report may include various timestamps corresponding to when the feed message was delivered, viewed, and operated.

### Mobile Wallet Side Operations

As discussed above, a user interacts with the feed messaging system 100 via the mobile wallet 124. More specifically, the user inputs commands via the input unit or the display unit 208 of the mobile device 102. In general, the commands may be classified into two categories: wallet server interaction and feed message interaction.

### Wallet Server Interaction

With respect to wallet server interaction, Table 12 below shows a plurality of APIs stored on the wallet server 106 which are exposed to the mobile wallet 124.

TABLE 12
APIs Exposed to the Mobile Wallet

| No. | API | Description |
|---|---|---|
| T1200 | Get New Message | Get list of message sources which the |
| | Sources For Wallet | mobile wallet can subscribe to. |
| T1210 | Create Message | Allows the mobile wallet to |
| | Subscription | subscribe to a message source. |
| T1220 | Cancel Message | Allows the mobile wallet to |
| | Subscription | discontinue a subscription |
| | | to a message source. |
| T1230 | Get New Messages for | Wallet server gets a list of messages |
| | Wallet | from a message source. |

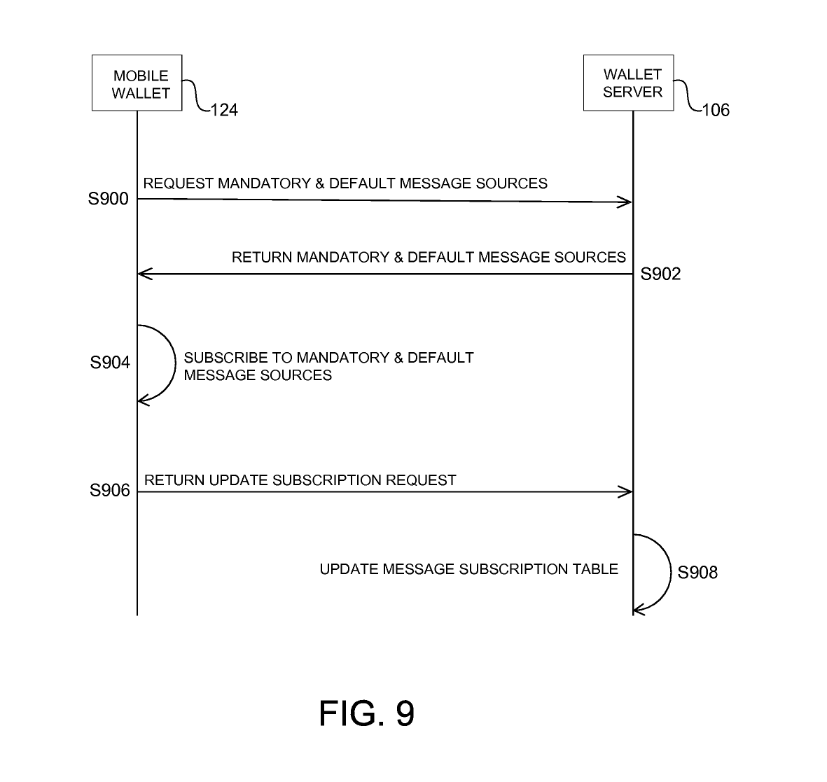

While the user may call any of the APIs shown in Table 14, the mobile wallet 124 is also configured to perform automatic enrollment into any message source which is designated “Mandatory” or “Default” when the mobile wallet 124 is activated. This initial synchronization is shown in FIG. 9. In step S900, the activated mobile wallet 124 connects with the wallet server 106 and requests a list of mandatory and default message sources. In response, in step S902, the wallet server 106 returns each database entry whose “Message Source Nature” field T106 is populated with “Mandatory” or “Default.” Upon receipt of this information, in step S904, corresponding entries are generated in the Mobile Wallet Message Source Database. The mobile wallet 124 then returns an “Update Subscription” request to the wallet server 106, the contents of which are shown below in Table 13, in step S906.

TABLE 13
Update Subscription Request

| No. | Field | Description |
|---|---|---|
| T1300 | Mobile Wallet ID | Unique identification of the |
| | | mobile wallet. |
| T1310 | Message Source ID | Unique identification of the feed |
| | | message source on the feed |
| | | messaging system. |
| T1320 | Message | Indicates whether the message |
| | Subscription Status | subscription is presently active |
| | | or not (Active/Discontinued). |
| T1330 | Message | Date/Time when the message source |
| | Subscription | is subscribed to or unsubscribed |
| | Timestamp | to by the user. |

Upon receipt of the update subscription request, the wallet server 106 generates a new entry in the Wallet Server Message Subscription Database 312 and populates that entry with a generated Message Subscription ID and with the information contained in the Update Subscription Request.

Of course, the user may choose to add message subscriptions after the initial synchronization, or simply view available messages sources, without subscribing.

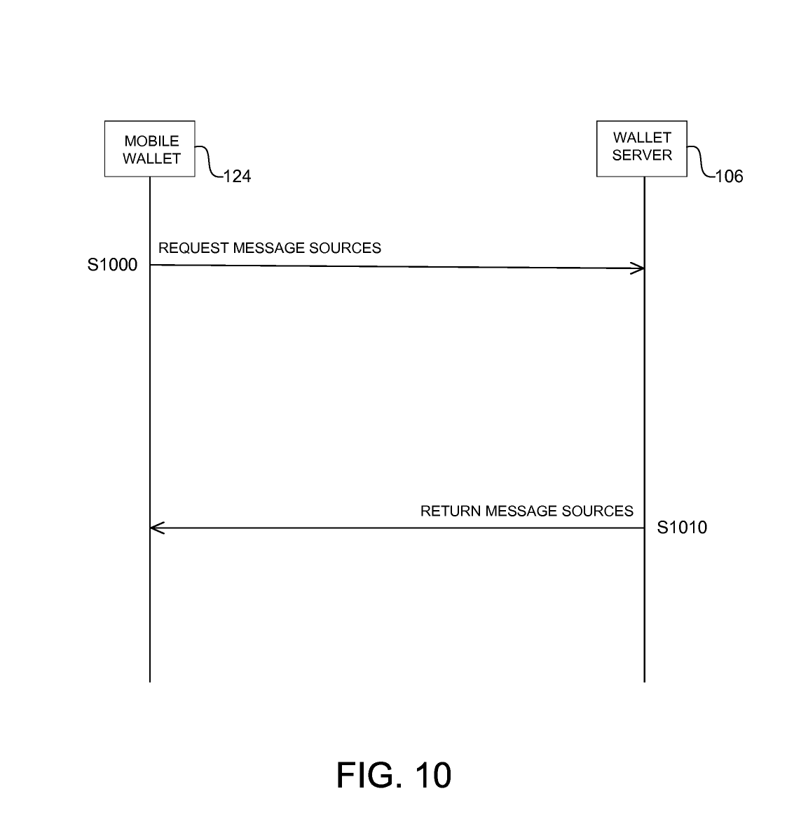

To view available message sources, the user calls the “Get New Message Sources For Wallet” API T1200. As shown in FIG. 10, the mobile wallet 124 sends a request for new message sources to the wallet server 106 (S1000). In response, the wallet server 106 returns a list of message sources to which the mobile wallet 124 may subscribe (S1010). The list of message sources may contain detailed information for each message source, including entries T100 and T102-T114 for each message source. Alternatively, the list of message sources may contain select values from Table 1 in order to minimize the amount of data that is transmitted to the mobile wallet 124.

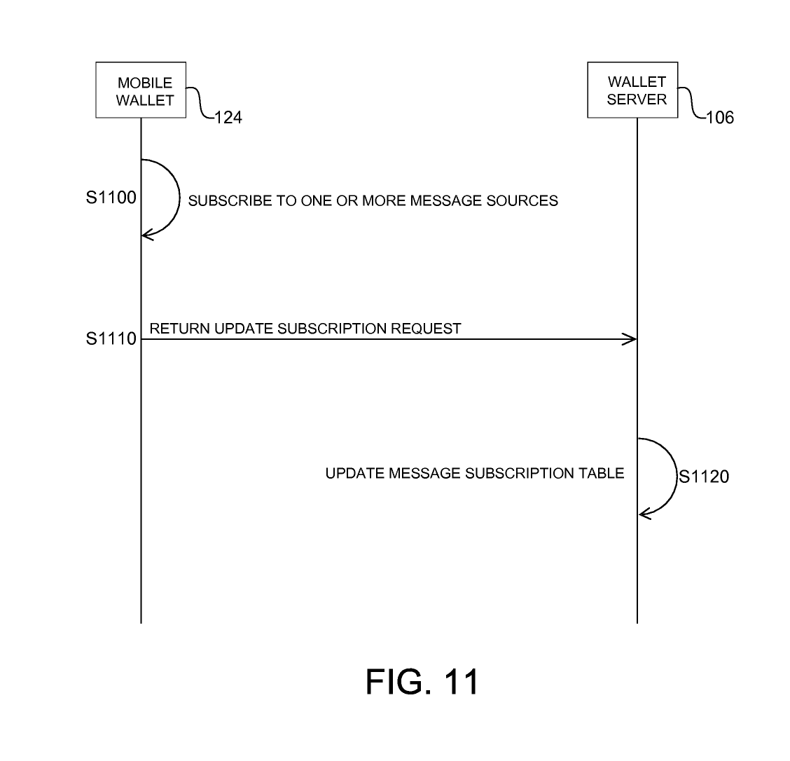

Upon receipt of the list of message sources the user may choose to add one or more message sources. To add a message source, the user calls, via the mobile wallet 124, the “Create Message Subscription” API 1210. As shown in FIG. 11, the user subscribes the mobile wallet 124 to one or more message sources (S1100) and the mobile wallet 124 returns an update subscription request with the information shown in Table 13. In step S1120, the wallet server 106 updates the Message Subscription Database 312 based upon the information contained in the Update Subscription Request.

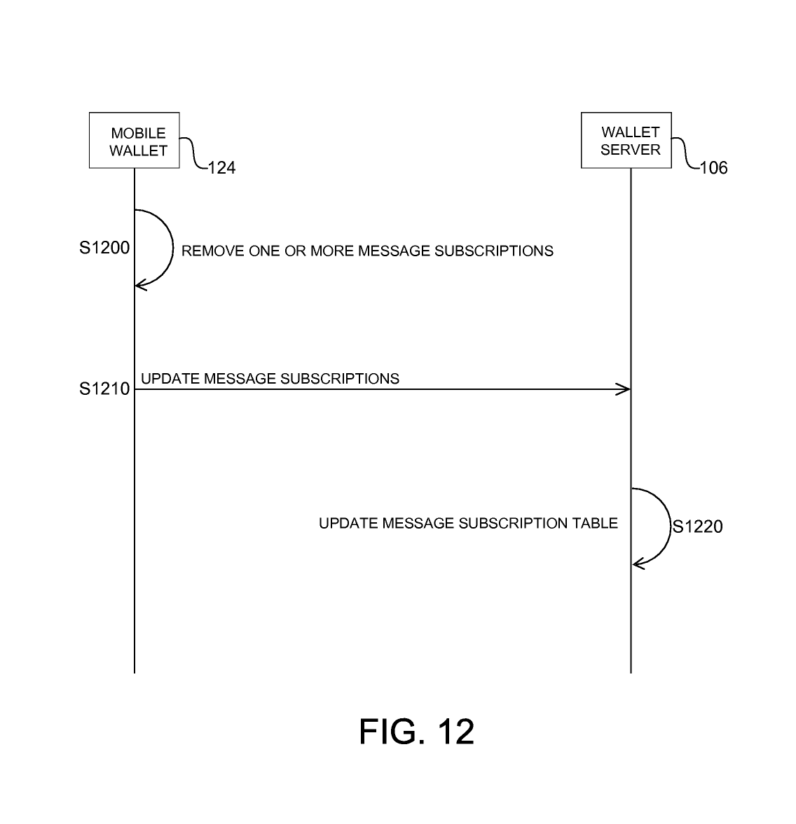

The user may also choose to discontinue one or more default and optional message subscriptions at any time after the mobile wallet 124 is activated. FIG. 12 is a sequence diagram showing the steps involved in removing a message subscription. In step S1200, the user elects to remove a default or optional message subscription; mandatory message subscriptions cannot be removed. The mobile wallet 124 sends an Update Subscription Request to the wallet server 106, which has a value in the Message Source ID field T1310 corresponding to the message source which is being unsubscribed from, a value of “Unsubscribed” in the Message Subscription Status field T1320, and the date and time the message source is unsubscribed from in the Message Subscription Timestamp field T1330. Upon receipt of the Message Subscription Acknowledgment, the wallet server 106 updates the Wallet Server Message Subscription 312 database accordingly.

A user may also choose to manually retrieve feed messages for the mobile wallet 124 at any time by calling the “Get New Messages for Wallet” API T1230. This process is also automatically executed at regular intervals in order to keep the mobile wallet 124 current. If the mobile wallet 124 determines that the mobile device 102 is unavailable to retrieve feed messages at one of the regular intervals, due to, for instance, the mobile device 102 being used by another program, the operation may be delayed until a time when the mobile device 102 is available.

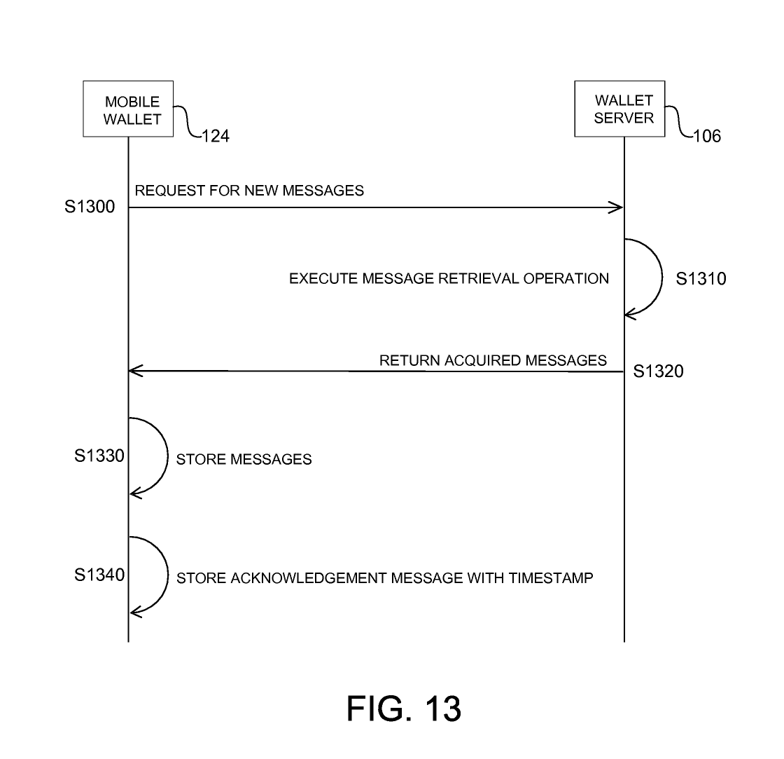

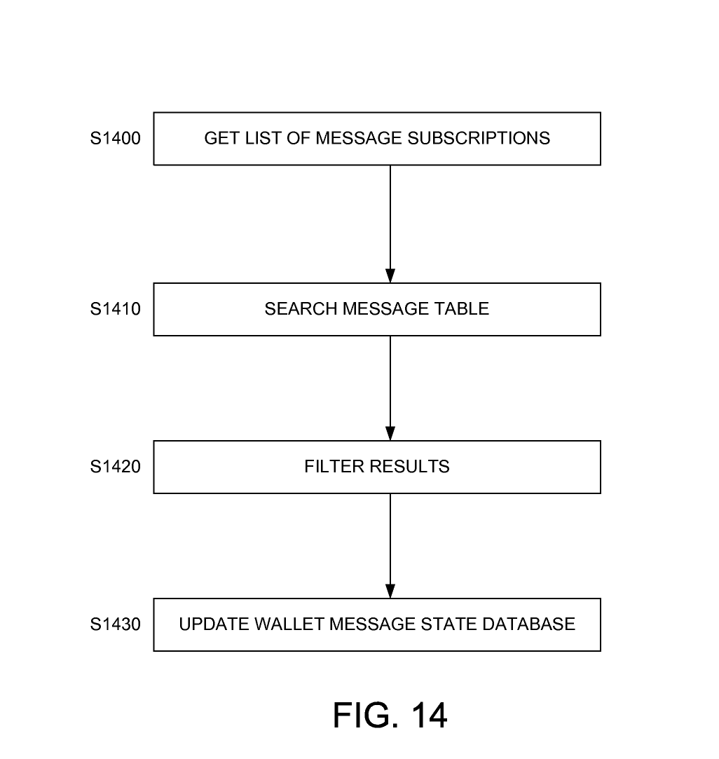

FIG. 13 shows the steps involved in getting feed messages from the wallet server 106. First, the mobile wallet 124 sends a request (S1300) to retrieve new messages. Upon receipt of the request for new messages, the wallet server 106 executes a message retrieval operation, as shown in FIG. 14.

In step S1400 of FIG. 14, the wallet server 106 retrieves a list of all message subscriptions corresponding to the mobile wallet 124 from the Wallet Server Message Subscription Database 312. From that list of message subscriptions, the wallet server 106 pulls the Message Source ID for each subscription and searches the Wallet Server Message Database 310 for all messages with a matching Message Source ID (S1410). The wallet server 106 then performs, in step S1420, a filtering operation, of filtering out retrieved messages which have a Message ID and Wallet ID which are not in the Mobile Wallet Message State Database 314. These filtered messages are those which have not yet been delivered to the mobile wallet 124. The wallet server 106 then packages these filtered feed messages for delivery, and updates the Mobile Wallet Message State Database 314 accordingly.

Returning to FIG. 13, once the wallet server has executed the message retrieval operation, the acquired feed messages are delivered to mobile wallet 124 (step S1320). The acquired messages are then stored in the memory 204 on the mobile device 124 (step S1330) and a corresponding acknowledgment message, the contents of which are shown below in Table 14, is generated and stored in the mobile wallet 1340 (S1340).

TABLE 14
Mobile Wallet Message Acknowledgment

| No. | Field | Description |
|---|---|---|
| T1400 | Message ID | Unique identification value of the feed message |
| | | on the feed messaging system. |
| T1410 | Message | Status of the feed message (Active/Discontinued/ |
| | Status | Expired). |
| T1420 | Timestamp | Date/Time when the feed message is received, |
| | | viewed, or operated. |

The acknowledgment message is one vehicle by which the wallet server 106 is informed of the operations which are carried out on the mobile wallet 124 by the user. For instance, when a feed message is received a corresponding message acknowledgment is generated which includes the message ID T1400 of the feed message, the message status T1410, and a timestamp T1420 indicating when the feed message was received. The message acknowledgment is stored on the memory 204 of the mobile device. When the feed message is viewed or operated, corresponding message acknowledgments are also generated and stored on the memory 204 of the mobile device 102.

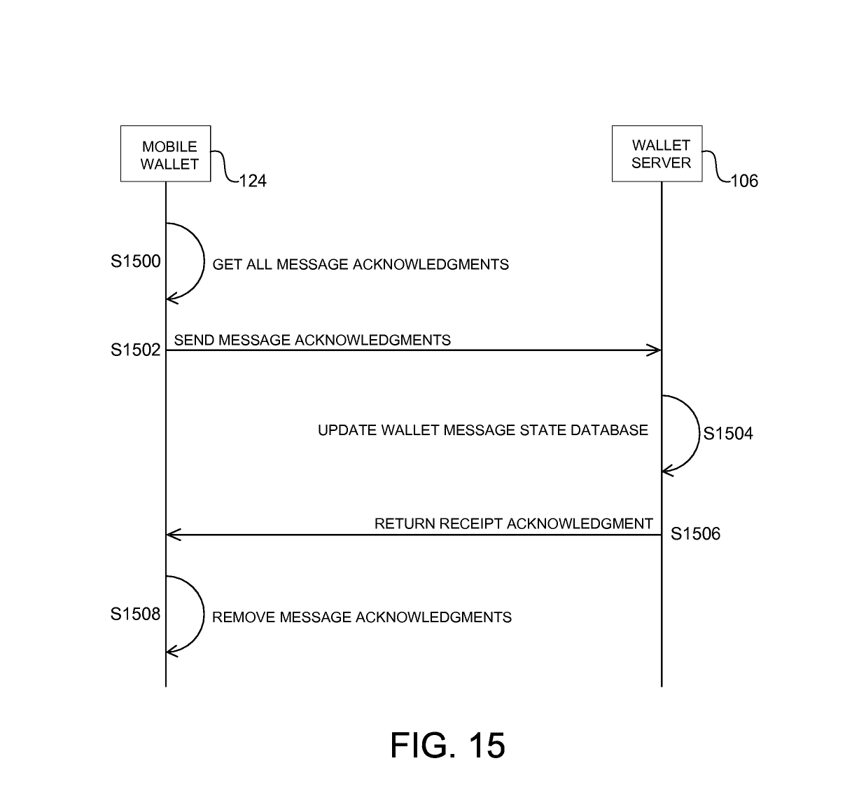

FIG. 15 is a sequence diagram illustrating a process for updating the wallet server 106 based on the generated message acknowledgments. In step S1500, the mobile wallet 124 collects the message acknowledgments stored therein, and then in step S1502 sends the collected message acknowledgments to the wallet server 106 during a synchronization operation. Upon receipt of the message acknowledgments, the wallet server 106 updates the Wallet Message State Database 314 to reflect the events which have occurred on the mobile wallet 124, and generates and sends a return receipt acknowledgment to the mobile wallet 124 in step S1506. The return receipt acknowledgment indicates that the information contained in the message acknowledgments has been successfully incorporated into the Wallet Message State Database 314, and thus grants the mobile wallet 124 permission to remove the sent message acknowledgments, which is done in step S1508.

### Feed Message Interaction

As noted above, the feed message includes a message body T625, and may also include a logo which is a full logo T655 and/or a partial logo T660 depending on the type of feed message. When the user interacts with the message body T625 or the logos T655 and T660, a specific operation may be performed in accordance with the values stored in Message Logo Action ID field T635 and the Body Action ID field T645 of the feed message. The specific programming instructions for those operations are included in the Logo Action Parameters field T640 and Body Action Parameters field T650.

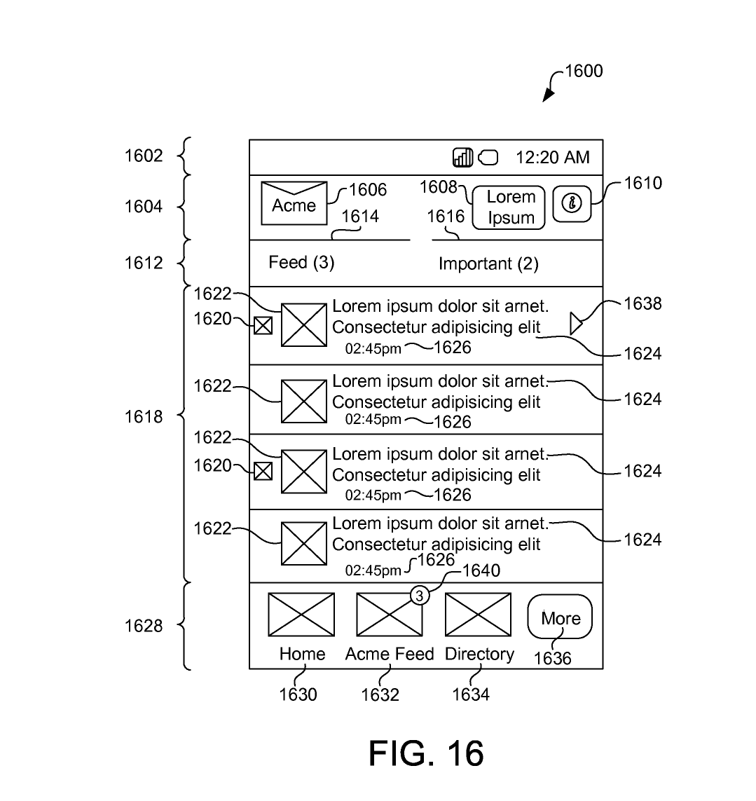

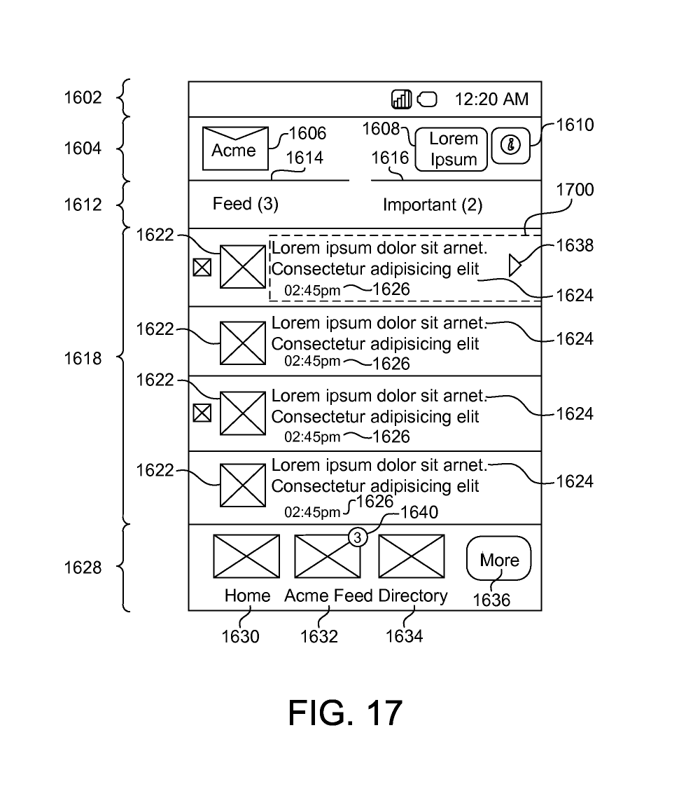

FIG. 16 is an exemplary view of a display screen 1600 generated by the display unit 208 of the mobile device 102 when the “Acme Feed” button 1632 is designated. As noted above, in one embodiment the display unit 208 is a touch sensitive display (such as a capacitive touch display) and receives commands by a user touching a certain area of the display unit 208. As shown in FIG. 17, the display screen 1600 contains a plurality of elements which will be described further below.

At the top of the display screen 1600 is a bar 1602 which shows basic information relating to the status of the mobile device 102. Below that is a graphic bar 1604 which contains an image 1606 corresponding to the operator of the feed messaging system 100, a directory icon 1608, and an information icon 1610. The directory icon 1608, when designated, returns a display screen showing a directory of service providers. The information icon 1610 when designated returns additional information about the elements shown on the display screen 1600. Below the graphic bar 1604 is a feed message type bar 1612 which includes a feed tab 1614 and an important tab 1616. The feed tab 1614 contains feed messages from message sources which are designated as “Default” or “Optional.” The important tab 1616 contains feed messages from message sources which are designated as “Mandatory.” In parentheses next to both the word “feed” and “important” are the number of messages respectively corresponding to each tab. As the user views each feed message, these numbers are updated accordingly. The feed button 1632 may also include a number 1640 indicating the number of feed messages which have not been read.

Below the feed message type bar 1612 is a feed message display area 1618 in which the feed messages are displayed. When the feed tab 1614 is designated, the feed messages corresponding to the “Default” and “Optional” message sources are displayed in the feed message display area 1618. Similarly, when the important tab 1616 is designated, feed messages corresponding to the “Mandatory” message sources are displayed in the feed message display area 1618.

The feed message display area 1618 may be configured to display one or more feed messages. The user may configure the mobile wallet 124 to display the feed messages at a font size and type of their choosing. In one embodiment, when the user touches the feed message display area 1618 and swipes their finger in an up or down direction, the feed messages are scrolled accordingly. In one embodiment, each feed message includes a selectable box 1620 for selecting the feed message, an image 1622 corresponding to the message source, an excerpt 1624 of the message body content, and a timestamp 1626 showing when the feed message was received. The image 1622 may be either the full logo T655 or the partial logo T660 contained in the feed message.

Below the feed message display area 1618 is a navigational bar containing navigation icons 1630, 1632, 1634, and 1636 which allow the user to change the display screen. When the user designates the “Home” icon 1630, then the display unit 208 displays a home screen for the mobile wallet 124 (not shown). When the user designates the directory icon 1634, the display unit 208 displays the directory of service providers. When the user designates the “More” icon 1636, the display unit 208 display additional content as dictated by the mobile wallet 124.

As discussed above, the body content of the feed message may be associated with the programming instructions. In one embodiment, if the body content is associated with programming instructions, then a chevron 1638 will appear next to the excerpt 1624. The user may then contact the area 1700 of the feed message corresponding to the body content, and swipe to the right to execute the associated programming instructions, as shown in FIG. 17.

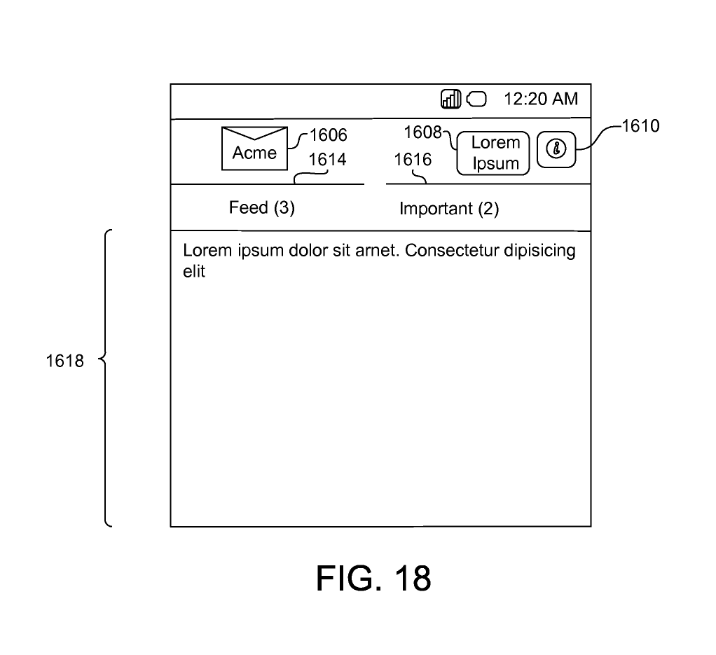

If the user designates a feed message for viewing, by tapping on the body content of the feed message, listed under the feed message tab 1614, then the display unit 208 displays the corresponding feed message, as shown in FIG. 18. In FIG. 18, the feed message display area 1618 is populated with the Message Body T625 of the feed message.

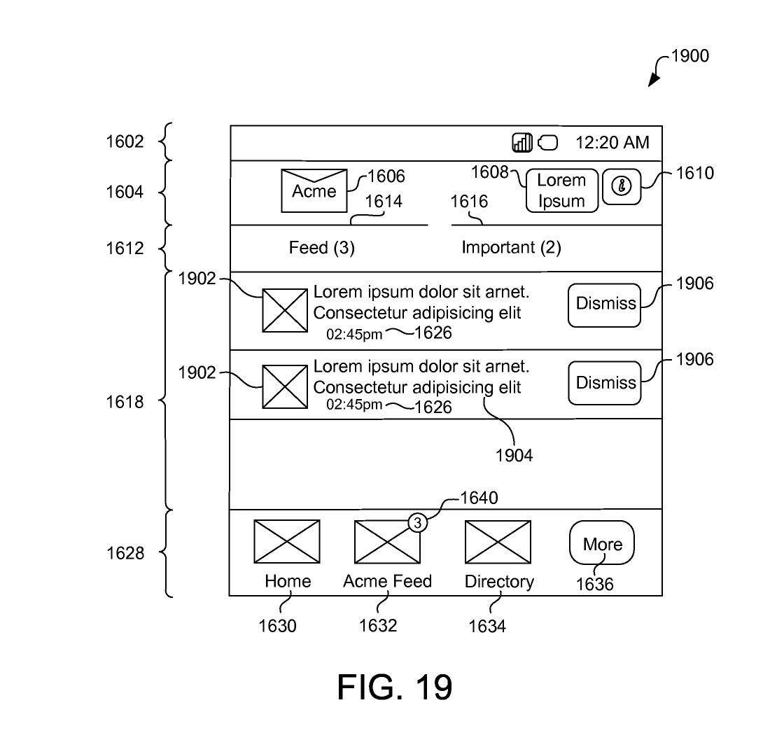

If the user designates the “important” tab 1616, then the display unit 208 displays a display screen 1900 as shown in FIG. 19. In FIG. 19, the feed message display area 1618 shows: an image 1902 corresponding to the mandatory message source, the message body 1904, and a dismissal button 1906 which allows the user to dismiss the corresponding feed message. Once all of the important feed messages are dismissed, the display unit 208 returns to the display screen 1600 shown in FIG. 16, and the number in parentheses next to the word “important” in the important tab 1616 is changed to zero.

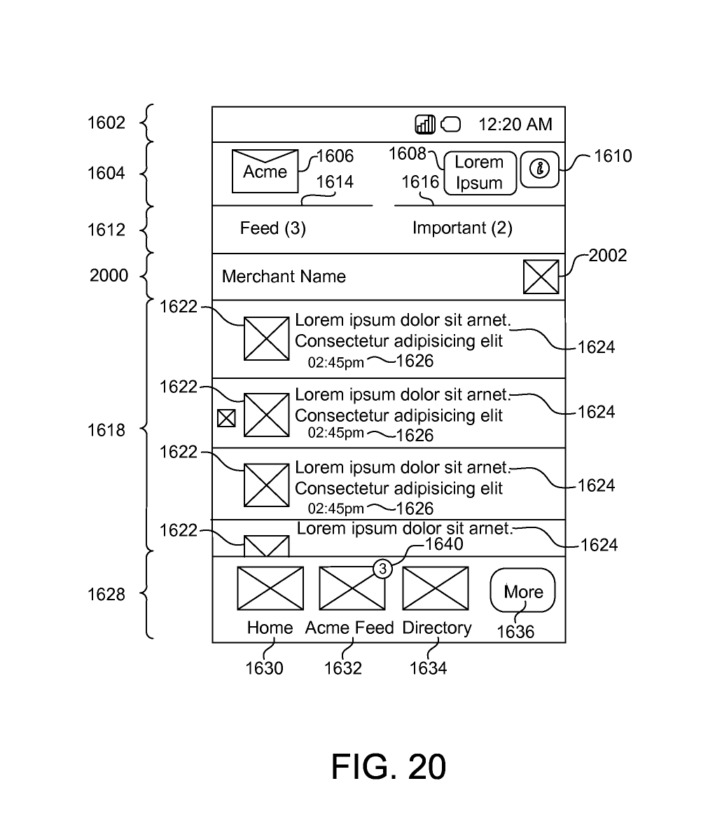

When a user designates an image 1622 associated with a particular feed message, the mobile wallet 124 filters the remaining feed messages and returns only those feed messages associated with the message source corresponding to that image. The display unit 208 then changes the display screen to show the filtered results, as shown in FIG. 20. In between the feed message display area 1618 and feed message type bar 1612, in FIG. 20, is a bar which shows the message source name 2000, corresponding to the filtered feed messages, and a selectable box 2002 which allows the user to unselect the filter and show all the received feed messages.

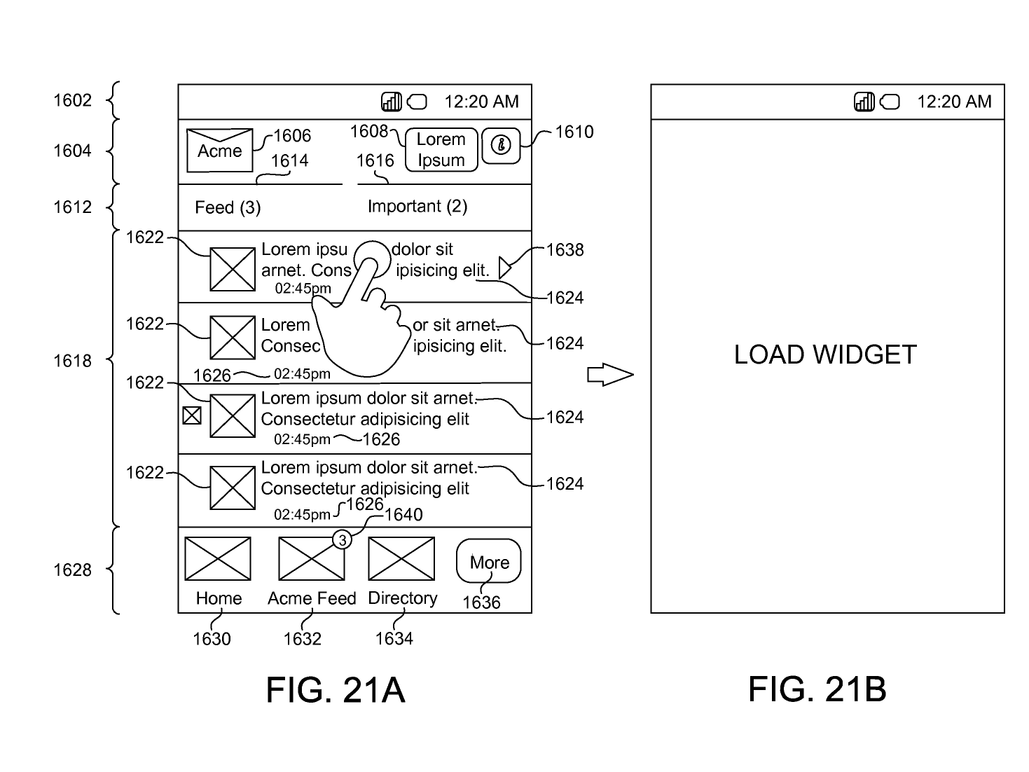

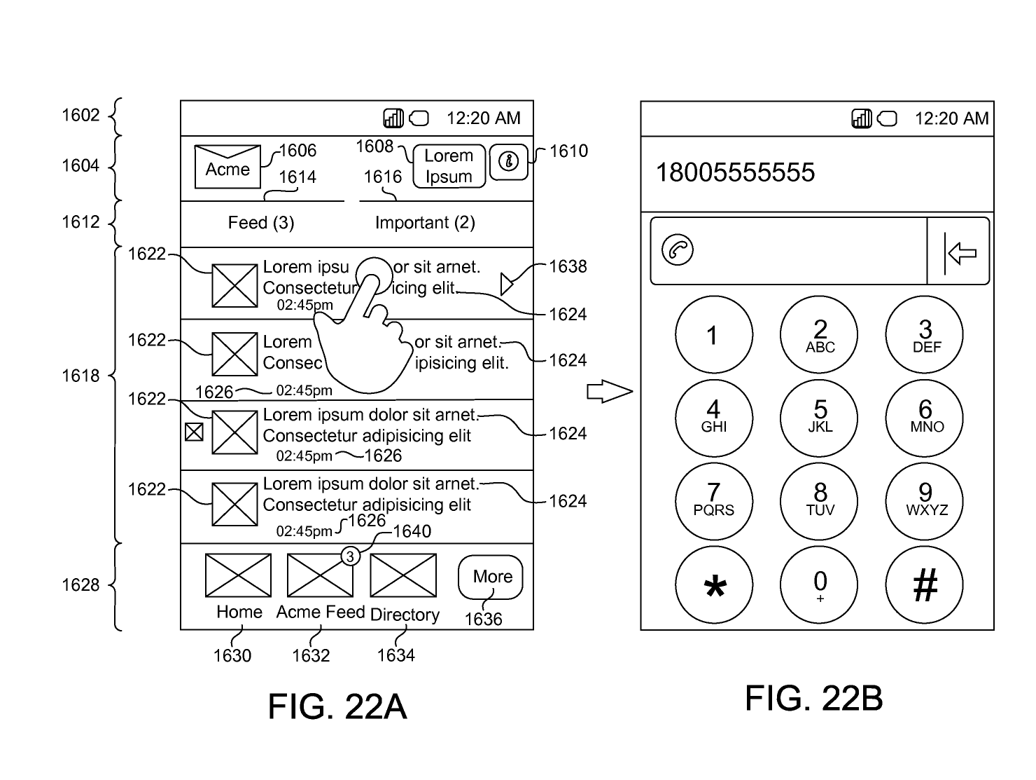

As discussed above, the message body T625 and the logo T655 and/or T660 may each be associated with programming content provider by the service provider in the body action parameters field T650 and the logo action parameters field T640. This programming may be able to call any function which can be realized by the mobile device 102, including, e.g., dialing a telephone number, opening a widget stored in the memory 204 or the secure element 210, or opening a web browser and loading a web page. FIG. 21A shows an example where a user swipes the feed message to the right to trigger the corresponding programming. In FIG. 21A, the user is contacting the message body 1624; thus the programming in the body action parameters field T650 is executed. In this example, the body action parameters field T650 contains programming instructions for loading a widget stored in the memory 204, and the display unit 208 changes the display screen accordingly, as shown in FIG. 21B. In FIG. 22A, the user also contacts the message body 1624 and swipes to the right. In this example, the body action parameters field T650 contains programming instructions to dial a specific telephone number. Thus, the mobile device 102 loads the telephone application and dials the number provided by the body action parameter field T650, as shown in FIG. 22B. As one of ordinary skill will appreciate, these actions could also be triggered by touching the logo 1622 and swiping to the right, if the logo action parameters field T640 contained the program instructions. Additionally, one set of programming instructions may be stored for the message body 1624, and another different set of programming instructions for the logo 1622, and activated by independent input commands.

### Consumer Profile Server

As discussed above, the wallet platform 104 also includes a consumer profile server 108. The consumer profile server 108 contains a processor and a memory, the memory storing one or more programs for generating and updating consumer profiles. As discussed above, the mobile device 102 periodically returns information regarding which messages have been received, viewed, and operated. From this information, the program in the consumer profile server 108 generates a profile for each mobile wallet 124. The program may also use information regarding which messages were not viewed or deleted in generating the consumer profiles. The consumer profiles are available to the service provider systems 114, 116, and 118 via the web portal 126 and the ESB 112, thus providing the service providers with information regarding the consumer's tendencies.

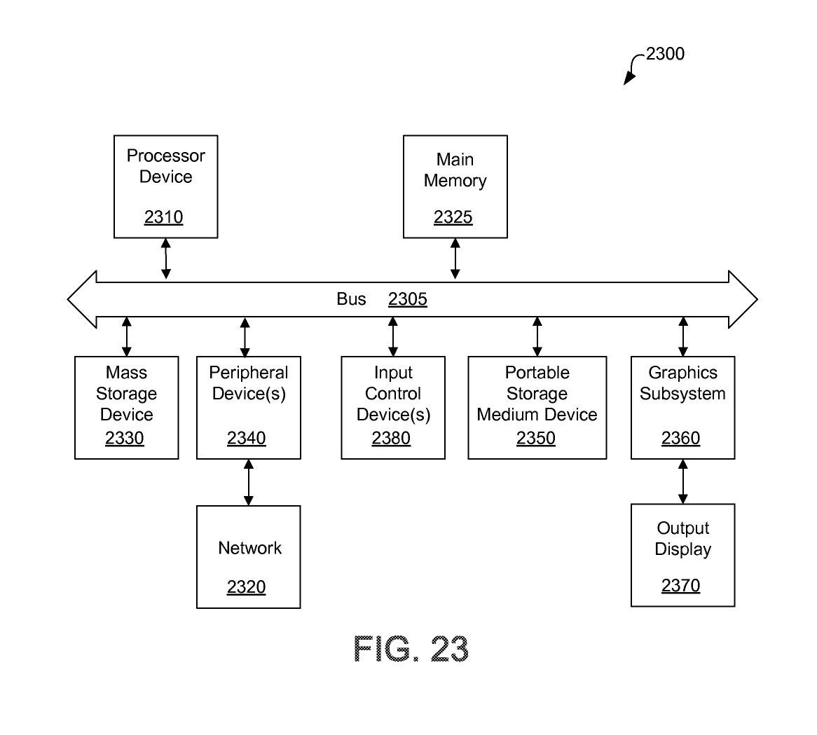

FIG. 23 is a block diagram of a general and/or special purpose computer 2300, which may be a general and/or special purpose computing device, in accordance with some of the example embodiments of the invention. The computer 2300 may be, for example, a user device, a user computer, a client computer and/or a server computer, among other things.

The computer 2300 may include without limitation a processor device 2310, a main memory 2325, and an interconnect bus 2305. The processor device 2310 may include without limitation a single microprocessor, or may include a plurality of microprocessors for configuring the computer 2300 as a multi-processor system. The main memory 2325 stores, among other things, instructions and/or data for execution by the processor device 2310. The main memory 2325 may include banks of dynamic random access memory (DRAM), as well as cache memory.

The computer 2300 may further include a mass storage device 2330, peripheral device(s) 2340, portable non-transitory storage medium device(s) 2350, input control device(s) 2380, a graphics subsystem 2360, and/or an output display interface 2370. For explanatory purposes, all components in the computer 2300 are shown in FIG. 23 as being coupled via the bus 2305. However, the computer 2300 is not so limited. Devices of the computer 2300 may be coupled via one or more data transport means. For example, the processor device 2310 and/or the main memory 2325 may be coupled via a local microprocessor bus. The mass storage device 2330, peripheral device(s) 2340, portable storage medium device(s) 2350, and/or graphics subsystem 2360 may be coupled via one or more input/output (I/O) buses. The mass storage device 2330 may be a nonvolatile storage device for storing data and/or instructions for use by the processor device 2310. The mass storage device 2330 may be implemented, for example, with a magnetic disk drive or an optical disk drive. In a software embodiment, the mass storage device 2330 is configured for loading contents of the mass storage device 2330 into the main memory 2325.

The portable storage medium device 2350 operates in conjunction with a nonvolatile portable storage medium, such as, for example, a compact disc read only memory (CD-ROM), to input and output data and code to and from the computer 2300. In some embodiments, the software for storing information may be stored on a portable storage medium, and may be inputted into the computer 2300 via the portable storage medium device 2350. The peripheral device(s) 2340 may include any type of computer support device, such as, for example, an input/output (I/O) interface configured to add additional functionality to the computer 2300. For example, the peripheral device(s) 2340 may include a network interface card for interfacing the computer 2300 with a network 2320.

The input control device(s) 2380 provide a portion of the user interface for a user of the computer 2300. The input control device(s) 2380 may include a keypad and/or a cursor control device. The keypad may be configured for inputting alphanumeric characters and/or other key information. The cursor control device may include, for example, a handheld controller or mouse, a trackball, a stylus, and/or cursor direction keys. In order to display textual and graphical information, the computer 2300 may include the graphics subsystem 2360 and the output display 2370. The output display 2370 may include a cathode ray tube (CRT) display and/or a liquid crystal display (LCD). The graphics subsystem 2360 receives textual and graphical information, and processes the information for output to the output display 2370.

Each component of the computer 2300 may represent a broad category of a computer component of a general and/or special purpose computer. Components of the computer 2300 are not limited to the specific implementations provided here.

Software embodiments of the example embodiments presented herein may be provided as a computer program product, or software, that may include an article of manufacture on a machine accessible or machine readable medium having instructions. The instructions on the non-transitory machine accessible machine readable or computer-readable medium may be used to program a computer system or other electronic device. The machine or computer-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “computer-readable”, “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

Portions of the example embodiments of the invention may be conveniently implemented by using a conventional general purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD or CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further includes software for performing example aspects of the invention, as described above.

Included in the programming and/or software of the general and/or special purpose computer or microprocessor are software modules for implementing the procedures described above.

While various example embodiments of the invention have been described above, it should be understood that they have been presented by way of example, and not limitation. It is apparent to persons skilled in the relevant art(s) that various changes in form and detail can be made therein. Thus, the disclosure should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. An apparatus constructed to receive a feed message from an external party system, comprising:
a memory;
a communication unit configured to receive at least one feed message from a mobile network, wherein the at least one feed message includes message content provided by an external party system and one or more sets of instructions; and
a processor configured to:
cause a display unit to display the message content, wherein the display unit is configured to receive one or more input commands,
generate a plurality of message acknowledgments, including any one of: (i) a received message acknowledgment when the at least one feed message is received by the communication unit, (ii) a viewed message acknowledgment when the message content is displayed on the display unit, and (iii) an operated message acknowledgment when the one or more sets of instructions are executed in accordance with the one or more input commands received by the display unit, or a combination thereof, and
store one or more of the plurality of message acknowledgments in the memory,
wherein the processor is further configured to synchronize with a remote server and transmit to the remote server the one or more message acknowledgments stored in the memory.

2. An apparatus according to claim 1, wherein the one or more sets of instructions, when executed, cause the processor to perform at least one of the following actions: dial a telephone number, open a web browser program stored in the memory and navigate to a web page, or execute a commerce widget stored in the memory.

3. An apparatus according to claim 1, wherein the message content includes a message body, an image, and a message priority designation of either important or normal.

4. An apparatus according to claim 1,
wherein the received message acknowledgment includes a timestamp corresponding to when the feed message was received by the communication unit,
wherein the viewed message acknowledgment includes a timestamp corresponding to when the message content is displayed on the display unit, and
wherein the operated message acknowledgment includes a timestamp corresponding to when the one or more sets of instructions were executed.

5. An apparatus according to claim 4,
wherein the at least one feed message further includes a message ID, and
wherein the received message acknowledgment, the viewed message acknowledgment, and the operated message acknowledgment each include the message ID.

6. An apparatus according to claim 5,
wherein the at least one feed message further includes message status information, and
wherein the received message acknowledgment, the viewed message acknowledgment, and the operated message acknowledgment each include the message status information.

7. An apparatus according to claim 1,
wherein the processor is further configured to delete the one or more of the plurality of message acknowledgments stored in the memory upon receipt of a return receipt acknowledgment by the communication unit from the mobile network.

8. A method of receiving a feed message and transmitting information related thereto, comprising:
receiving at least one feed message from a mobile network, wherein the at least one feed message includes message content and one or more sets of instructions provided by an external party system;
generating one or more message acknowledgments, including any one of: (i) a received message acknowledgment when the at least one feed message is received, (ii) a viewed message acknowledgment when the message content is displayed, and (iii) an operated message acknowledgment when the one or more sets of instructions are executed in accordance with one or more received input commands, or a combination thereof;
storing the one or more message acknowledgments in a memory; and
transmitting to a remote server the one or more message acknowledgments stored in the memory.

9. The method according to claim 8, further comprising:
performing an action corresponding to the one of more sets of instructions included in the feed message, wherein the action is at least one of: dialing a telephone number, opening a web browser program and navigating to a web page, or executing a commerce widget.

10. The method according to claim 8, wherein the message content includes a message body, an image, and a message priority designation of either important or normal.

11. The method according to claim 8,
wherein the received message acknowledgment includes a timestamp corresponding to when the feed message was received,
wherein the viewed message acknowledgment includes a timestamp corresponding to when the message content is displayed, and
wherein the operated message acknowledgment includes a timestamp corresponding to when the one or more sets of instructions were executed.

12. The method according to claim 11,
wherein the at least one feed message further includes a message ID, and
wherein the received message acknowledgment, the viewed message acknowledgment, and the operated message acknowledgment each include the message ID.

13. The method according to claim 12,
wherein the at least one feed message further includes message status information, and
wherein the received message acknowledgment, the viewed message acknowledgment, and the operated message acknowledgment each include the message status information.

14. The method according to claim 8, further comprising:
receiving a return receipt acknowledgment from the mobile network; and
deleting the one or more message acknowledgments stored in the memory upon receipt of the return receipt acknowledgment.

15. A non-transitory computer-readable medium having stored thereon one or more sequences of instructions for causing one or more processors to perform a method of receiving a feed message and transmitting information related thereto, the method comprising the steps of:
receiving at least one feed message from a mobile network, wherein the at least one feed message includes message content and one or more sets of instructions provided by an external party system;
generating one or more message acknowledgments, including any one of: (i) a received message acknowledgment when the at least one feed message is received, (ii) a viewed message acknowledgment when the message content is displayed, and (iii) an operated message acknowledgment when the one or more sets of instructions are executed in accordance with one or more received input commands, or a combination thereof;
storing the one or more message acknowledgments in a memory; and
transmitting to a remote server the one or more message acknowledgments stored in the memory.

16. The non-transitory computer readable medium according to claim 15,
wherein the method further comprises performing an action corresponding to the one of more sets of instructions included in the feed message, wherein the action is at least one of: dialing a telephone number, opening a web browser program and navigating to a web page, or executing a commerce widget.

17. The non-transitory computer readable medium according to claim 15, wherein the message content includes a message body, an image, and a message priority designation of either important or normal.

18. The non-transitory computer readable medium according to claim 15,
wherein the received message acknowledgment includes a timestamp corresponding to when the feed message was received,
wherein the viewed message acknowledgment includes a timestamp corresponding to when the message content is displayed, and
wherein the operated message acknowledgment includes a timestamp corresponding to when the one or more sets of instructions were executed.

19. The non-transitory computer readable medium according to claim 18,
wherein the at least one feed message further includes a message ID, and
wherein the received message acknowledgment, the viewed message acknowledgment, and the operated message acknowledgment each include the message ID.

20. The non-transitory computer readable medium according to claim 19,
wherein the at least one feed message further includes message status information, and
wherein the received message acknowledgment, the viewed message acknowledgment, and the operated message acknowledgment each include the message status information.
